(19) United States
(12) Patent Application Publication
(10) Pub. No.: US 2018/0084815 A1
(43) Pub. Date: Mar. 29, 2018

(54) ALGAE OR PLANT BASED EDIBLE COMPOSITIONS

(71) Applicant: New Wave Foods, San Francisco, CA (US)

(72) Inventor: Michelle Wolf, San Francisco, CA (US)

(21) Appl. No.: 15/716,272

(22) Filed: Sep. 26, 2017

Related U.S. Application Data
(60) Provisional application No. 62/399,877, filed on Sep. 26, 2016.

(51) Int. Cl. A23L 33/17; A23L 19/00; A23L 33/22; A23L 5/42; A23P 30/10

(52) U.S. Cl. CPC A23L 33/17; A23L 19/00; A23V 2002/00; A23L 5/42; A23P 30/10; A23L 33/22

(57) ABSTRACT

Provided herein are edible compositions that mimic the organoleptic properties of seafood, as well as methods of making and using the same.

### CROSS-REFERENCE To RELATED APPLICATIONS

This application claims the benefit under 35 U.S.C. 119(e) of U.S. Provisional Application No. 62/399,877, filed on Sep. 26, 2016, which is incorporated by reference.

### BACKGROUND

Rising environmental concerns have increased the interest in developing sustainable food products. For instance, the exploitation and depletion of fisheries across the world has generated interest in the fabrication of seafood-substitute products. However, conventional seafood-substitute products are limited in their ability to replicate both the texture and flavor of seafood, particularly shrimp, due to the selection and ratios of particular ingredients included therein, and the use of synthetic aromatic compounds for flavor. Often, these conventional seafood-substitute products do not have the elasticity or breakdown during mastication as compared to their wild-caught or farmed counterparts, nor do they accurately replicate the sensation and intensity of the taste of seafood.

### SUMMARY

The edible compositions disclosed herein, such as those that comprise a particular combination of a hydrocolloid material, a plant derived protein material, and a flavoring agent including at least one algal extract, have been surprisingly found to mimic the organoleptic properties of seafood, and particularly shrimp.

The present disclosure, according to one embodiment, thus provides an edible composition comprising a hydrocolloid material; at least one protein material; and at least one algal extract.

In one embodiment, the hydrocolloid material of the edible composition is present in an amount from about 0.5 wt. % to about 20 wt. %. In one embodiment, the hydrocolloid material is present in an amount from about 0.5 wt. % to about 10 wt. %. In one embodiment, the hydrocolloid material is present in an amount from about 1 wt. % to about 8 wt. %.

In one embodiment, the hydrocolloid material of the edible composition comprises at least two different hydrocolloid compositions. In one embodiment, a weight ratio of the at least two different hydrocolloid compositions is from about 5:1 to about 1:5. In one embodiment, the weight ratio of the at least two different hydrocolloid compositions is about 1:1. In one embodiment, a first of the hydrocolloid compositions is present in an amount from about 0.5 wt. % to about 10 wt. %, and a second of the hydrocolloid compositions is present in an amount from about 0.5 wt. % to about 10 wt. %. In one embodiment, the first of the hydrocolloid compositions comprises high acyl gellan gum and/or the second of the hydrocolloid compositions comprises low acyl gellan gum. In one embodiment, the first of the hydrocolloid compositions comprises one or more of konjac gum, microcrystalline cellulose, and sodium carboxymethyl cellulose, and/or the second of the hydrocolloid compositions comprises sodium alginate.

In one embodiment, the hydrocolloid material of the edible composition is sodium alginate. In one embodiment, the hydrocolloid material is sodium alginate and is present in an amount from about from about 0.5 wt. % to about 10 wt. %. In one embodiment, the hydrocolloid material is sodium alginate, and is present in an amount from about 1 wt. % to about 8 wt. %.

In one embodiment, the at least one protein material of the edible composition is present in an amount from about 0.1 wt. % to about 30 wt. %

In one embodiment, the at least one protein material of the edible composition is a protein isolate, such as soy isolate. In one embodiment, the protein material is a protein concentrate, such as soy concentrate. In one embodiment, the protein material is selected from a soy protein isolate, a soy protein concentrate, a pea protein isolate, a pea protein concentrate, a rice protein isolate, a rice protein concentrate, a potato protein isolate, a potato protein concentrate, a chick-pea protein isolate, a chick-pea protein concentrate, an algal isolate, an algal concentrate, and combinations thereof. In one embodiment, the protein material is a soy protein concentrate. In one embodiment, the protein material is present in an amount from about 0.1 wt. % to about 30 wt. %, and is a soy protein isolate, a soy protein concentrate, or a combination thereof. In one embodiment, the protein material is present in an amount from about 0.1 wt. % to about 30 wt. %, and is a soy protein concentrate.

In one embodiment, the at least one algal extract of the edible composition is present in an amount from about 0.0001 wt. % to about 1 wt. %.

In one embodiment, the at least one algal extract of the edible composition comprises astaxanthin. In one embodiment, the at least one algal extract comprises an extract from Haematococcus pluvialis. In one embodiment, the at least one algal extract is in the form of an algae oil.

In one embodiment, the edible composition further comprise at least one salt. In one embodiment, the at least one salt is present in an amount from about 0.001 wt. % to about 3 wt. %.

In one embodiment, the at least one salt of the edible composition comprises calcium chloride. In one embodiment, the salt of the edible composition comprises calcium chloride, sodium chloride, calcium lactate, sodium citrate, calcium hydroxide, and combinations thereof. In one embodiment, the salt is present in an amount from about 0.001 wt. % to about 3 wt. %, and is calcium chloride.

In one embodiment, the edible composition further comprises at least one oil; at least one sugar; and/or water. In one embodiment, the edible composition further comprises at least one oil; at least one sugar; and water.

In one embodiment, the edible composition comprises the at least one oil. The at least one oil may be an additional oil, e.g., in instances where the at least one algal extract is in the form of an oil. In one embodiment, the at least one oil is present in an amount from about 0.1 wt. % to about 10 wt. %. In one embodiment, the at least one oil is present in an amount from about 1 wt. % to about 7 wt. %.

In one embodiment, the at least one oil of the edible composition is selected from algae oil, olive oil, avocado oil, and combinations thereof In one embodiment, the oil is olive oil. In one embodiment, the oil is algae oil. In one embodiment, the oil is olive oil. In one embodiment, the oil is present in an amount from about 0.1 wt. % to about 10 wt. %, and is algae oil. In one embodiment, the oil is present in an amount from about 1 wt. % to about 7 wt. %, and is algae oil.

In one embodiment, the edible composition comprises the at least one sugar. In one embodiment, the at least one sugar is present in an amount from about 0.1wt. % to about 6 wt. %.

In one embodiment, the edible composition comprises water. In one embodiment, the water is present in an amount from about 50 wt. % to about 95 wt. %.

In one embodiment, the edible composition further comprises a dietary fiber. In one embodiment, the dietary fiber is present in an amount from about 0.1 wt. % to about 2 wt. %. In one embodiment, the dietary fiber is selected from bamboo fiber, citrus fiber, and combinations thereof. In one embodiment, the dietary fiber is present in an amount from about 0.1 wt. % to about 2 wt. %, and is bamboo fiber.

In one embodiment, the edible composition comprises one or more additional ingredients selected from: a salt in an amount from about 0.001 wt. % to about 3 wt. %; an oil present in an amount from about 1 wt. % to about 7 wt. %; a sugar present in an amount from about 0.1 wt. % to about 6 wt. %; a dietary fiber present in amount from about 0.1 wt. % to about 2 wt. %; and water present in an amount from about 50 wt. % to about 95 wt. %.

In one embodiment, the edible composition further comprises at least one color additive (or coloring agent). In one embodiment, the color additive is selected from lycopene, paprika, beta-carotene, and combinations thereof

In one embodiment, the edible composition comprises no more than about 0.001 wt. % of starch, and/or no more than about 0.001 wt. % of gluten.

In one embodiment, the edible composition comprises no more than about 0.001 wt. % of products or byproducts of animal origin.

In one embodiment, the edible composition is a seafood substitute product. In one embodiment, the edible composition is a shrimp substitute product having the form of a shrimp.

The present disclosure also provides seafood substitute products for human consumption, which do not contain (e.g., contain no more than about 0.001 wt. % of) products or byproducts of animal origin, and yet mimic/share one or more properties of wild-caught or farmed seafood.

The present disclosure, according to one embodiment, thus provides a seafood substitute product for human consumption comprising: at least two hydrocolloid compositions present in a weight ratio from about 5:1 to about 1:5; at least one protein material present in an amount from 0.1 wt. % to about 30 wt. %; and at least one flavoring agent present in an amount from about 0.001 wt. % to about 5 wt. %.

In one embodiment, one of the at least two hydrocolloid compositions of the seafood substitute product comprises high acyl gellan gum in an amount from about 0.5 wt. % to about 10 wt. %. In one embodiment, one of the at least two hydrocolloid compositions comprises low acyl gellan gum in an amount from about 0.5 wt. % to about 10 wt. %.

In one embodiment, one of the at least two hydrocolloid compositions of the seafood substitute product comprises sodium alginate in an amount from about 0.5 wt. % to about 10 wt. %. In one embodiment, one of the at least two hydrocolloid compositions of the seafood substitute product comprises konjac gum and/or one or more cellulose derivatives (e.g., microcrystalline cellulose and/or sodium carboxymethylcellulose), wherein the total combined amount of the konjac gum and/or cellulose derivative(s) is from about 0.5 wt. % to about 10 wt. %.

The present disclosure, according to another embodiment, provides a seafood substitute product for human consumption comprising: a hydrocolloid material present in an amount from about 1 wt. % to about 8 wt. %; a protein material present in an amount from about 0.1 wt. % to about 30 wt. %; and an algal extract present in an amount from about 0.0001 wt. % to about 1 wt. %. In some embodiments, the hydrocolloid material of this seafood substitute product comprises or consists of sodium alginate.

In one embodiment, the seafood substitute products disclosed herein further comprise from about 0.001 wt. % to about 3 wt. % of a salt; from about 0.1 wt. % to about 10 wt. % of an oil; from about 0.1 wt. % to about 6 wt. % of a sugar; from about 0.001 wt. % to about 3 wt. % of dietary fiber (e.g., bamboo fiber); and/or from about 50 wt. % to about 95 wt. % of water.

In one embodiment, the seafood substitute products disclosed herein are shrimp substitute products. In one embodiment, the seafood substitute product disclosed herein are in a form of a shrimp.

In one embodiment, the seafood substitute products disclosed herein comprise no more than about 0.001 wt. % of products or byproducts of animal origin, and have the same texture, form, and appearance of wild-caught or farmed shrimp.

The present disclosure additionally provides methods of making the edible compositions or seafood substitute products disclosed herein.

The present disclosure, according to one embodiment, thus provides a first method of making an edible composition as disclosed herein, where the method comprises: combining at least one hydrocolloid material, at least one protein material and water to form a first solution; adding at least one oil to the first solution after a predetermined amount of time has elapsed from combining the at least one hydrocolloid material, the at least one protein material and the water; heating the first solution; combining at least one sugar and at least one salt to form a second solution; heating the second solution; and combining the first and second solutions to form the edible composition.

In one embodiment, the first solution is heated to a temperature ranging from about 85° C. to about 100° C., and/or the second solution is heated to a temperature ranging from about 60° C. to about 95° C.

In one embodiment, the first method further comprises: adding the edible composition to a mold having a predetermined shape; removing the edible composition from the mold, the edible composition having the predetermined shape of the mold when removed therefrom; and adding a flavoring agent to the edible composition having the predetermined shape. In one embodiment, the predetermined shape corresponds to a crescent shape of a shrimp with no tail or head.

In one embodiment, the flavoring agent utilized in the first method imparts a red color to the edible composition having the predetermined shape. In one embodiment, the flavoring agent is an algae oil. In one embodiment, the flavoring agent is an algal extract comprising astaxanthin. In embodiments in which the flavoring agent may not impart a red color to the edible composition, said composition may further include a coloring agent comprising at least one of: paprika, lycopene, and beta-carotene. In one embodiment, adding the flavoring agent and/or the coloring agent comprises coating one or more portions of an outer surface of the shaped edible composition with the flavoring agent and/or the coloring agent.

In one embodiment, the first method further comprises: adding the edible composition to one or more molds, each independently having a predetermined shape; optionally adding a coloring agent to the edible composition when present in the one or more molds; and removing the edible composition from the one or more molds, the edible composition having the predetermined shape of the respective molds from which it was removed. In one embodiment, the coloring agent may be sprayed/coated on one or more portions of each mold prior to addition of the edible composition thereto. The coloring agent may thus be transferred to one or more portions of the edible composition upon addition of the composition to the molds.

The present disclosure, according to one embodiment, provides a second method of making an edible composition, where the method comprises: hydrating at least one protein material in water for a first predetermined time period; combining a hydrocolloid material with the hydrated protein material to form a first mixture; adding at least one sugar, a first salt, one or more flavoring agents, and bamboo fiber to the first mixture to form a second mixture; adding a first solution comprising a second salt and water to the second mixture to form a third mixture; and depositing the third mixture in a second solution comprising a third salt and water for a second predetermined time period.

In one embodiment the second method further comprises a process for forming the hydrocolloid material, where the process comprises: combining a first hydrocolloid composition and a second hydrocolloid composition with water to form a third solution; and adding an acid salt and an alkali slurry to the third solution to form the hydrocolloid material, wherein the alkali slurry comprises an alkali salt and water.

In one embodiment, the second method further comprises removing the third mixture from the second solution, and molding the third mixture to have a predetermined shape, such as that of a shrimp.

### BRIEF DESCRIPTION OF THE DRAWINGS

Embodiments of the invention may be more readily understood by referring to the accompanying drawings in which:

FIGS. 1A-1B illustrate exterior and interior portions, respectively, of an edible composition having the form of a shrimp, according to one embodiment.

FIGS. 2A-2B illustrate breaded and non-breaded (raw) shrimp substitute products, respectively, along with exemplary dimensions thereof, according to one embodiment.

FIG. 3 illustrates a flowchart of a method of making an edible composition, according to one embodiment.

### DETAILED DESCRIPTION

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Unless the context requires otherwise, throughout the present specification and claims, the word “comprise” and variations thereof, such as, “comprises” and “comprising” are to be construed in an open, inclusive sense, that is as “including, but not limited to.” Additionally, the singular forms “a,” “an” and “the” include plural referents unless the context clearly dictates otherwise. For instance, reference to “the compound” includes a plurality of such compounds.

As used herein, the term “about” used in the context of quantitative measurements means the indicated amount ±10%. For example, “about 2:8” would mean 1.8-2.2:7.2-8.8.

Recitation of numeric ranges of values throughout the disclosure is intended to serve as a shorthand notation of referring individually to each separate value falling within the range inclusive of the values defining the range, and each separate value is incorporated in the specification as if it were individually recited herein.

The present disclosure, in one embodiment, provides edible compositions that mimic the organoleptic properties, appearance, texture, elasticity, and nutritional benefits of seafood. As used herein, the term “seafood” includes all freshwater or saltwater fish, shellfish, and crustaceans. In one embodiment, the edible compositions are shrimp-substitute products for human consumption, and thus mimic the organoleptic properties, appearance, texture, elasticity, and nutritional benefits of wild-caught or farmed shrimp.

In one embodiment, the edible compositions disclosed herein are vegan compositions comprising substantially no (e.g., less than 1%, 0.5% or 0.1% based on the total weight of the edible composition) products or byproducts of animal origin. For instance, in one embodiment, the edible compositions comprise a mixture of plant and/or bacteria derived gums, plant derived proteins, and one or more additional ingredients such as water, which when combined form a slurry. This slurry may be processed using particular time, temperature and/or pressure specifications, as discussed below, to ultimately produce an edible composition having a texture that more closely replicates the breakdown of seafood, and specifically shrimp, during mastication thereof as compared to current seafood substitute products. Moreover, other edible compositions disclosed herein, such as those comprising sodium alginate in combination with, or as a replacement for, the aforementioned mixture of plant and/or bacteria derived gums, also have a texture that likewise replicates the breakdown of seafood (e.g., shrimp) during mastication thereof.

In one embodiment, the edible compositions disclosed herein comprise no more than about 0.1 wt. %, about 0.001 wt. %, or about 0.0001 wt. % of products or byproducts of animal origin. In one embodiment, the edible compositions disclosed herein comprise no more than about 0.0001 wt. % of products or byproducts of animal origin.

In one embodiment, one or more of the ingredients in the edible compositions disclosed herein may qualify as FDA approved food additives, FDA approved color additives, FDA approved colorants, or GRAS (generally recognized as safe) materials. In one embodiment, each of the ingredients falls within one of more of: an FDA approved food additive, an FDA approved color additive, an FDA approved colorant, and a GRAS material.

In one embodiment, the edible compositions disclosed herein comprise a hydrocolloid material; at least one protein material; and at least one flavoring agent. In one embodiment, the flavoring agent comprises an algal extract. In one embodiment, the disclosed edible compositions further comprise: at least one salt, at least one oil, and/or water. The disclosed edible compositions may also optionally include one or more additional ingredients such as sugar, preservatives, emulsifiers, anti-caking agents, color additives (also referred to herein as coloring agents), acids, dietary fiber, etc.

In one embodiment, the present disclosure provides an edible composition comprising: about 0.5 wt. % to about 20 wt. % of a hydrocolloid material; about 0.1 wt. % to about 30 wt. % of a protein material; and 0.0001 wt. % to about 5 wt. % of a flavoring agent, preferably including an algal extract, wherein the weight percentages are based on the total weight of the edible composition. In one embodiment, the hydrocolloid material may comprise at least two different types of hydrocolloid compositions, where a total amount of one of the hydrocolloid compositions is from about 0.5 wt. % to about 10 wt. % based on the total weight of the edible composition, and a total amount of the other of the hydrocolloid compositions is from about 0.5 wt. % to about 10 wt. % based on the total weight of the edible composition. In one embodiment, the edible composition further comprises about 0.001 wt. % to about 3 wt. % of a salt; about 0.1 wt. % to about 10 wt. % of an oil; about 0.1 wt. % to about 6 wt. % of a sugar; about 0.001 wt. % to about 3 wt. % of dietary fiber; and/or about 50 wt. % to about 95 wt. % of water, wherein the weight percentages are based on the total weight of the edible composition.

In one embodiment, the present disclosure provides a seafood substitute product for human consumption comprising: at least two hydrocolloid compositions present in a weight ratio from about 5:1 to about 1:5; at least one protein material present in an amount from 0.1 wt. % to about 30 wt. % based on the total weight of the seafood substitute product; and at least one flavoring agent present in an amount from about 0.001 wt. % to about 5 wt. % based on the total weight of the seafood substitute product. In one embodiment, the seafood substitute product further comprises: from about 0.001 wt. % to about 3 wt. % of a salt; from about 0.1 wt. % to about 10 wt. % of an oil; from about 0.1 wt. % to about 6 wt. % of a sugar; from about 0.001 wt. % to about 3 wt. % of dietary fiber; and/or from about 50 wt. % to about 95 wt. % of water, wherein the weight percentages are based on the total weight of the seafood substitute product.

In one embodiment, the edible compositions and/or seafood substitute products disclosed herein comprise: high acyl gellan gum; low acyl gellan gum; soy isolate; and an algal extract comprising astaxanthin. In one embodiment, the edible compositions and/or seafood products disclosed herein comprise from about 0.5 wt. % to about 10 wt. % of high acyl gellan gum; from about 0.5 wt. % to about 10 wt. % of low acyl gellan gum; from about 0.1 wt. % to about 30 wt. % of a soy isolate; and from about 0.001 wt. % to about 1 wt. % of an algal extract comprising astaxanthin, wherein the weight percentages are based on the total weight of the applicable edible composition and/or seafood product. In one embodiment, the ratio of high acyl gellan gum to low acyl gellan gum is from about 1:5 to about 5:1. In one embodiment, the ratio of high acyl gellan gum to low acyl gum is about 1:1.

In one embodiment, the edible compositions and/or seafood substitute products disclosed herein comprise: high acyl gellan gum; low acyl gellan gum; a soy isolate; an algal extract comprising astaxanthin; olive oil; calcium chloride; sugar; and deionized water. In one embodiment, the edible compositions and/or seafood substitute products disclosed herein comprise: from about 0.5 wt. % to about 10 wt. % of high acyl gellan gum; from about 0.5 wt. % to about 10 wt. % of low acyl gellan gum; from about 0.1 wt. % to about 30 wt. % of a soy isolate; from about 0.001 wt. % to about 1 wt. % of an algal extract comprising astaxanthin; from about 0.1 wt. % to about 10 wt. % of extra virgin olive oil; from about 0.001 wt. % to about 3 wt. % of calcium chloride; from about 0.1 wt. % to about 6 wt. % of white, granulated sugar; and from about 50 wt. % to about 95 wt. % of deionized water, wherein the weight percentages are based on the total weight of the applicable edible composition and/or seafood product.

In one embodiment, the edible compositions and/or seafood substitute products disclosed herein comprise: about 1.9 wt. % high acyl gellan gum; about 1.9 wt. % low acyl gellan gum; about 6.8 wt. % soy isolate; about 0.05 wt. % of an algal extract comprising; about 0.6 wt. % extra virgin olive oil; about 0.02% of calcium chloride; about 1 wt. % of white, granulated sugar; and about 87.7 wt. % water.

In one embodiment, the edible compositions and/or seafood substitute products disclosed herein may comprise none (0 wt. % based on the total weight of the edible composition or seafood substitute product) or substantially none (e.g., less than about 1 wt. %, preferably less than about 0.01 wt. %, and more preferably less than about 0.001 wt. % based on the total weight of the edible composition or seafood substitute product) of each of the following: starch, wheat gluten, agar, alginate, carrageenan, cassia gum, cellulose gum, curdlan gum, guar gum, hydroxypropyl cellulose, konjac, locust bean gum, pectin and xanthin gum, soy lecithin, calcium stearoyl di laciate, polyglycerol ester, sorbitan ester, polypropylene glycol ester, sugar ester, monoglyceride, acetylated monoglyceride, lactylated monoglyceride, tricalcium phosphate, sodium carbonate, potassium carbonate, ammonium carbonate, magnesium carbonate, hydrochloric acid, potassium chloride, ammonium chloride, magnesium chloride, sodium chloride, stannous chloride, sodium sulfate, potassium sulfate, calcium sulfate, ammonium sulfate, magnesium sulfate, copper sulfate, aluminium sulfate, aluminium sodium sulfate, aluminium potassium sulfate, aluminium ammonium sulfate, sodium hydroxide, potassium hydroxide, calcium hydroxide, ammonium hydroxide, magnesium hydroxide, calcium oxide, magnesium oxide, sodium ferrocyanide, potassium ferrocyanide, calcium ferrocyanide, dicalcium diphosphate, sodium aluminium phosphate, magnesium stearate, calcium stearate, sodium gluconate, potassium gluconate, calcium gluconate, ferrous gluconate, ferrous lactate, sodium silicate, silicon dioxide, calcium silicate, sodium aluminium silicate, sulfuric acid, potassium aluminium silicate, aluminium calcium silicate, bentonite, kaolin, stearic acid, gluconic acid, glucono delta-lactone, citric acid, malic acid, tartric acid, acetic acid, oxalic acid, tannic acid, butyric acid, of benzoate, benzoic acid, nitrite, sulfur dioxide, sodium sorbate, butylated hydroxyanisole, sodium nitrate, sodium benzoate, ethylenediamine tetraacetic acid (EDTA), avocado oil, sunflower oil, safflower oil, palm oil, coconut oil, and combinations thereof.

In one embodiment, the edible compositions and/or seafood substitute products disclosed herein comprise: a hydrocolloid material comprising konjac gum, sodium alginate, microcrystalline cellulose, and/or sodium carboxymethyl cellulose; soy isolate; and an algal extract in the form of an oil. In one embodiment, the edible compositions and/or seafood products disclosed herein comprise from about 0.5 wt. % to about 20 wt. % of a hydrocolloid material selected from konjac gum, sodium alginate, microcrystalline cellulose, sodium carboxymethylcellulose, and combinations thereof; from about 0.1 wt. % to about 30 wt. % of a soy isolate; and from about 0.001 wt. % to about 5 wt. % of an algal extract in the form of an oil, wherein the weight percentages are based on the total weight of the applicable edible composition and/or seafood product. In one embodiment, the hydrocolloid material of the edible compositions and/or seafood products disclosed herein comprises a first hydrocolloid composition comprising one or more of konjac gum, microcrystalline cellulose, and sodium carboxymethylcellulose, and a second hydrocolloid composition comprising sodium alginate, wherein the weight ratio of the first hydrocolloid composition to the second hydrocolloid composition is from about 1:5 to about 5:1. In one embodiment, the weight ratio of the first hydrocolloid composition to the second hydrocolloid composition is about 2.5:1. In one embodiment, the hydrocolloid material of the edible compositions and/or seafood products disclosed herein comprises Seagel® XP 3428 and Protanal® RF 6650.

In one embodiment, the edible compositions and/or seafood substitute products disclosed herein comprise: a first hydrocolloid composition comprising konjac gum, microcrystalline cellulose, starch (e.g., modified and/or native starch), and sodium carboxymethylcellulose; a second hydrocolloid composition comprising sodium alginate; a soy isolate; an algae oil; bamboo fiber, salt (e.g., sodium chloride); calcium lactate; calcium hydroxide, sodium citrate; sugar; and water. In one embodiment, the edible and/or seafood substitute products further comprise one or more vegan shrimp flavoring additives, and/or one or more color additives. In one embodiment, the edible compositions and/or seafood substitute products disclosed herein comprise: from about 0.5 wt. % to about 10 wt. % of the first hydrocolloid material comprising konjac gum, microcrystalline cellulose, starch (e.g., modified and/or native starch), and sodium carboxymethylcellulose; from about 0.5 wt. % to about 10 wt. % of the second hydrocolloid composition comprising sodium alginate; from about 0.1 wt. % to about 30 wt. % of a soy isolate; from about 0.001 wt. % to about 5 wt. % of an algae oil; from about 0.001 wt. % to about 3 wt. % of bamboo fiber; from about from about 0.001 wt. % to about 3 wt. % of sodium chloride; from about from about 0.0001 wt. % to about 1 wt. % of calcium lactate; from about 0.0001 wt. % to about 1 wt. % of calcium hydroxide, from about 0.0001 wt. % to about 1 wt. % of sodium citrate; from about 0.1 wt. % to about 6 wt. % of sugar; from about 50 wt. % to about 95 wt. % of water, wherein the weight percentages are based on the total weight of the applicable edible composition and/or seafood product. In one embodiment, the edible compositions and/or seafood substitute products disclosed herein further comprise: from about 0.001 wt. % to about 2 wt. % of vegan shrimp flavoring additives; and/or from about 0.001 wt. % to about 2 wt. % of color additives, such as lycopene, wherein the weight percentages are based on the total weight of the applicable edible composition and/or seafood product.

In one embodiment, the edible compositions and/or seafood substitute products disclosed herein comprise: about 3.4 wt. % of first hydrocolloid composition comprising konjac gum, microcrystalline cellulose, starch (modified and native starch), and sodium carboxymethylcellulose; about 1.4 wt. % of a second hydrocolloid composition comprising sodium alginate; about 10 wt. % soy isolate; about 1 wt. % of bamboo fiber; about 2.5 wt. % of an algal oil; about 0.5% of sodium chloride; about 0.1 wt. % of calcium lactate; about 0.03 wt. % of calcium hydroxide; about 0.1 wt. % of sodium citrate; about 0.4 wt. % of vegan shrimp flavoring additive; about 1.2 wt. % of sugar; and about 79.4 wt. % water, wherein the weight percentages are based on the total weight of the applicable edible composition and/or seafood product.

In one embodiment, the edible compositions and/or seafood substitute products disclosed herein comprise: about 3.4 wt. % of a first hydrocolloid composition comprising konjac gum, microcrystalline cellulose, starch (modified and native starch), and sodium carboxymethylcellulose; about 1.4 wt. % of a second hydrocolloid composition sodium alginate; about 10 wt. % soy isolate; about 1 wt. % of bamboo fiber; about 2.5 wt. % of an algal oil; about 0.5% of sodium chloride; about 0.1 wt. % of calcium lactate; about 0.03 wt. % of calcium hydroxide; about 0.1 wt. % of sodium citrate; about 0.4 wt. % of a lycopene color additive; about 0.4 wt. % of vegan shrimp flavoring additive; about 1.2 wt. % of sugar; and about 79.0 wt. % water, wherein the weight percentages are based on the total weight of the applicable edible composition and/or seafood product.

In one embodiment, the first hydrocolloid material of the edible compositions and/or seafood products disclosed herein comprises from about 30 wt. % to about 60 wt. % of konjac gum; from about 7 wt. % to about 13 wt. % microcrystalline methylcellulose; from about 7 wt. % to about 13 wt. % modified starch; from about 15 wt. % to about 40 wt. % native starch; and from about 0.5 wt. % to about 1.5 wt. % of sodium carboxymethylcellulose, wherein the weight percentages are based on the total weight of the first hydrocolloid material.

In one embodiment, the present disclosure provides an edible composition comprising: about 0.5 wt. % to about 10 wt. % of a hydrocolloid material; about 0.1 wt. % to about 30 wt. % of a protein material; and about 0.0001 wt. % to about 1 wt. % of an algal extract, wherein the weight percentages are based on the total weight of the edible composition. In one embodiment, the edible composition further comprises one or more additional ingredients selected from: a salt in an amount from about 0.001 wt. % to about 3 wt. %; an oil present in an amount from about 1 wt. % to about 7 wt. %; a sugar present in an amount from about 0.1 wt. % to about 6 wt. %; a dietary fiber present in amount from about 0.1 wt. % to about 2 wt. %; a coloring agent present in an amount from about 0.0001 wt. % to about 1 wt. %; and water present in an amount from about 50 wt. % to about 95 wt. %. In one embodiment, the hydrocolloid material comprises sodium alginate. In one embodiment, the protein material is a protein isolate or a protein concentrate. In one embodiment, the protein material is selected from a soy protein isolate, a soy protein concentrate, a pea protein isolate, a pea protein concentrate, a rice protein isolate, a rice protein concentrate, a potato protein isolate, a potato protein concentrate, a chick-pea protein isolate, a chick-pea protein concentrate, an algal isolate, an algal concentrate, or combinations thereof. In one embodiment, the protein material is a soy protein isolate, a soy protein concentrate, or combinations thereof. In one embodiment, the protein material is a soy concentrate. In one embodiment, the algal extract comprises an extract from Haematococcus pluvialis. In one embodiment, the algal extract comprises astaxanthin. In one embodiment, the salt comprises calcium chloride. In one embodiment, the salt comprises sea salt. In one embodiment, the oil is selected from algae oil, olive oil, avocado oil, and combinations thereof. In one embodiment, the oil is algae oil. In one embodiment, the sugar is evaporated cane juice. In one embodiment, the dietary fiber is selected from bamboo fiber, citrus fiber, and combinations thereof. In one embodiment, the coloring agent may be selected from lycopene, paprika, beta-carotene, and combinations thereof. In one embodiment, the coloring agent is lycopene. In one embodiment, the water is sea water. In one embodiment, the edible composition comprises no more than about 0.001 wt. % of starch. In one embodiment, the edible composition comprises no more than about 0.001 wt. % of gluten. In one embodiment, the edible composition is a seafood substitute product suitable, e.g., for human consumption. In one embodiment, the edible composition is a shrimp substitute product having the form of a shrimp.

In one embodiment, the present disclosure provides an edible composition comprising: sodium alginate; a soy protein isolate or soy protein concentrate or a combination thereof an algal extract comprising astaxanthin; algae oil; sugar (e.g., evaporated cane juice); calcium lactate; sea salt; bamboo fiber; sodium citrate; and optionally one or more additional flavoring agents (e.g., shrimp flavoring agents). In one embodiment, the edible composition comprises: about 1 wt. % to about 8 wt. % of sodium alginate; about 0.1 wt. % to about 30 wt. % of soy concentrate; about 0.0001 wt. % to about 1 wt. % of an algal extract comprising astaxanthin; about 0.001 wt. % to about 3 wt. % of sea salt; about 1 wt. % to about 7 wt. % of algae oil; about 0.1 wt. % to about 6 wt. % of a sugar (e.g., evaporated cane juice); about 0.1 wt. % to about 2 wt. % of bamboo fiber; optionally about 0.0001 wt. % to about 1 wt. % of a coloring agent comprising lycopene; optionally about 0.0001 wt. % to about 1 wt. % of additional vegan flavoring agents (e.g., vegan shrimp flavoring agents); and about 50 wt. % to about 95 wt. % of water, wherein the weight percentages are based on the total weight of the edible composition.

In one embodiment, the present disclosure provides an edible composition comprising: about 3.9 wt. % of sodium alginate; about 10 wt. % of soy protein concentrate; about 1.15 wt. % of sea salt; about 2.75 wt. % of algae oil; about 4.8 wt. % of evaporated cane juice; about 0.8 wt. % of bamboo fiber; about 0.8% of additional flavoring agents (e.g., vegan shrimp flavoring agents); about 0.01 wt. % of calcium lactate; and the remainder water, wherein the weight percentages are based on the total weight of the edible composition.

In one embodiment, the present disclosure provides an edible composition with enhanced color. In one embodiment, the edible composition with enhanced color comprises: about 99% of an edible composition disclosed herein, and about 1 wt. % of a coloring agent disclosed herein, wherein the weight percentages are based on the total weight of the edible composition with enhanced color. In one embodiment, the edible composition with enhanced color comprises: about 3.86 wt. % of sodium alginate; about 9.90 wt. % of soy protein concentrate; about 1.14 wt. % of sea salt; about 2.72 wt. % of algae oil; about 4.75 wt. % of evaporated cane juice; about 0.79 wt. % of bamboo fiber; about 0.8% of additional flavoring agents (e.g., vegan shrimp flavoring agents); about 0.0089 wt. % of calcium lactate; about 0.99 wt. % of the coloring agent; and the remainder water, wherein the weight percentages are based on the total weight of the edible composition with enhanced color.

Hydrocolloid Material(s)

The edible compositions disclosed herein comprise a hydrocolloid material, in one embodiment. As used herein, a hydrocolloid material refers to a colloid system in which the colloid particles comprise a network of polymers dispersed in water. As also used herein, a colloid system refers to a state of matter in which solid colloid particles are dispersed throughout a medium. Hydrocolloid materials may exist as a sol, or as a gel that exhibits solid or solid-like behavior with characteristic strength, brittleness, and/or hardness dependent on the structure of the colloid particles (e.g., polymers) present. For a hydrocolloid material in a gel state, the polymers therein may be crosslinked with one another via one or more cross-linking agents. For instance, hydrocolloid gels comprising anionic polysaccharides may utilize cationic cross-linking agents such as mono- or multivalent metal ions. Hydrocolloid materials may also be reversible (i.e., able to alternate between the gel and sol state via temperature modulation), or irreversible (i.e., unable to alternate between the gel and sol state). In one embodiment, the edible compositions disclosed herein comprise an irreversible (e.g., non-thermoreversible) hydrocolloid material that forms a gel.

In one embodiment, the total amount of the hydrocolloid material present in the edible compositions disclosed herein is from about 0.5 wt. % to about 20 wt. % based on the total weight of the edible composition. In one embodiment, the total amount of the hydrocolloid material is from about 1 wt. % to about 20 wt. %, about 2 wt. % to about 20 wt. %, about 3 wt. % to about 20 wt. %, about 4 wt. % to about 20 wt. %, about 5 wt. % to about 20 wt. %, about 8 wt. % to about 20 wt. %, about 10 wt. % to about 20 wt. %, about 15 wt. % to about 20 wt. %, about 0.5 wt. % to about 15 wt. %, about 1 wt. % to about 15 wt. %, about 2 wt. % to about 15 wt. %, about 3 wt. % to about 15 wt. %, about 4 wt. % to about 15 wt. %, about 5 wt. % to about 15 wt. %, about 8 wt. % to about 15 wt. %, about 10 wt. % to about 15 wt. %, about 12 wt. % to about 15 wt. %, about 0.5 wt. % to about 10 wt. %, about 1 wt. % to about 10 wt. %, about 2 wt. % to about 10 wt. %, about 3 wt. % to about 10 wt. %, about 4 wt. % to about 10 wt. %, about 5 wt. % to about 10 wt. %, about 8 wt. % to about 10 wt. %, about 0.5 wt. % to about 8 wt. %, about 1 wt. % to about 8 wt. %, about 2 wt. % to about 8 wt. %, about 3 wt. % to about 8 wt. %, about 4 wt. % to about 8 wt. %, about 5 wt. % to about 8 wt. %, about 6 wt. % to about 8 wt. %, about 0.5 wt. % to about 5 wt. %, about 1 wt. % to about 5 wt. %, about 2 wt. % to about 5 wt. %, about 3 wt. % to about 5 wt. %, or about 4 wt. % to about 50 wt. % based on the total weight of the edible composition.

In one embodiment, the total amount of the hydrocolloid material is about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 6 wt. %, about 8 wt. %, about 10 wt. %, about 12 wt. %, about 14 wt. %, about 16 wt. %, about 18 wt. %, or about 20 wt. % based on the total weight of the edible composition. In one embodiment, the total amount of the hydrocolloid material is about 4.0 wt. % based on the total weight of the edible composition.

In one embodiment, the hydrocolloid material comprises at least one polysaccharide. The repeating units of the at least one polysaccharide may be regular, branched, and/or connected by glycosidic linkages. In one embodiment, the hydrocolloid material comprises at least one anionic polysaccharide.

Suitable hydrocolloid materials for the edible compositions disclosed herein include, but are not limited to, agar, alginate, sodium alginate, carrageenan, cassia gum, cellulose gum, curdlan gum, guar gum, cellulose derivatives such as hydroxypropyl cellulose, hydroxypropylmethyl cellulose, microcrystalline cellulose, and/or carboxymethyl cellulose, konjac, locust bean gum, pectin, xanthan gum, high acyl gellan gum, low acyl gellan gum, combinations thereof, etc.

In one embodiment, the hydrocolloid material comprises two or more (e.g., 2, 3, 4, 5, 6, etc.) different hydrocolloids compositions, where each hydrocolloid composition comprises one or more hydrocolloids. Different hydrocolloid compositions may differ from one another with respect to one or more of: composition, molecular weight, degree of polymerization, etc. In other words, a first hydrocolloid composition and a second hydrocolloid composition may be considered different where at least one hydrocolloid of the first hydrocolloid composition has a different chemical composition, degree of polymerization, and/or molecular weight, etc. than at least one hydrocolloid of the second hydrocolloid composition. For instance, a hydrocolloid material may comprise two different hydrocolloid compositions in embodiments where a first hydrocolloid composition comprises low acyl gellan gum and a second hydrocolloid composition comprises high acyl gellan gum, or in embodiments where a first hydrocolloid composition and a second hydrocolloid composition comprise the same hydrocolloid albeit with different molecular weights and/or degrees of polymerization. Different hydrocolloid compositions may also differ with respect to the quantity of hydrocolloids included therein. For instance, a first hydrocolloid composition comprising only one hydrocolloid may be different than a second hydrocolloid composition comprising more than one hydrocolloid.

In one embodiment in which the hydrocolloid material comprises two different hydrocolloid compositions, a weight ratio of the two different hydrocolloid compositions is from about 5:1 to about 1:5, from about 4:1 to about 1:4, from about 3:1 to about 1:3, or from about 2:1 to about 1:2. In one embodiment, the weight ratio of the two different hydrocolloid compositions is about 1:1.

In one embodiment in which the hydrocolloid material comprises two different hydrocolloid compositions, a total amount of one of the hydrocolloid compositions is from about 0.5 wt. % to about 10 wt. % based on the total weight of the edible composition, and/or a total amount of the other of the hydrocolloid compositions is from about 0.5 wt. % to about 10 wt. %, based on the total weight of the edible composition. In one embodiment, the hydrocolloid material comprises about 2 wt. % of a first hydrocolloid composition, and about 2 wt. % of a second hydrocolloid composition, wherein the weight percentages of the first and second hydrocolloid compositions are based on the total weight of the edible composition.

In one embodiment, the hydrocolloid material of the edible compositions disclosed herein comprises gellan gum in its native form (high acyl gellan gum), and/or deacetylated gellan gum (low acyl gellan gum). Gellan gum is an extracellular polysaccharide produced by the bacterium Pseudomonas elodea. Gellan gum comprises a tetracyclic repeating unit that includes rhamnose, glucuronic acid, and glucose in a molar ratio of 1:1:2. High acyl gellan gum comprises two acyl substituents—acetate and glycerate—on one of the glucose residues. These two acyl substituents are absent in low acyl gellan gum.

Both high acyl gellan gum and low gellan gum form gels, with high acyl gellan gum typically forming soft, elastic gels, and low acyl gellan gum typically forming firm, brittle gels. In embodiments in which the hydrocolloid material comprises both high acyl gellan gum and low acyl gellan gum, it has been surprisingly found that about a 1:1 weight ratio of high acyl gellan gum to low acyl gellan gum results in a texture (as characterized, e.g., by hardness, modulus, fracture strain, springiness, and/or shear strength) equivalent, or substantially equivalent, to that of seafood, and particularly to that of shrimp. In one embodiment, the edible compositions disclosed herein may further comprise optional cationic species (e.g., calcium, magnesium, sodium, potassium, etc.), and soluble solids such as sucrose or other sugars to optimize the texture of the high acyl and low acyl gellan gums.

In one embodiment, the hydrocolloid material of the edible compositions disclosed herein thus comprises low acyl gellan gum and high acyl gellan gum. In one embodiment, the weight ratio of low acyl gellan gum to high acyl gellan gum is from about 5:1 to about 1:5, about 4:1 to about 1:4, about 3:1 to about 1:3, about 2:1 to about 1:2, or preferably about 1:1. In one embodiment, the edible compositions disclosed herein comprise about 1.94 wt. % high acyl gellan gum, and about 1.94 wt. % low acyl gellan gum, wherein the weight percentages of the high acyl and low acyl gellan gums are based on the total weight of the edible composition.

In one embodiment, including but not limited to those in which the edible compositions disclosed herein comprise a combination of low acyl gellan gum and high acyl gellan gum, said compositions may include none (0 wt. % based on the total weight of the edible composition) or substantially none (e.g., less than about 1 wt. %, preferably less than about 0.01 wt. %, and more preferably less than about 0.001 wt. % based on the total weight of the edible composition) of the following: agar, alginate, carrageenan, cassia gum, cellulose gum, curdlan gum, guar gum, cellulose derivatives such as hydroxypropyl cellulose, hdyroxypropylmethyl cellulose, or carboxymethyl cellulose, konjac, locust bean gum, pectin, xanthan gum, combinations thereof, and other hydrocolloid(s) found in conventional edible compositions as would be apparent to skilled artisans upon reading the present disclosure.

In one embodiment, the hydrocolloid material of the edible compositions disclosed herein comprises konjac gum. Konjac gum comprises glucomannan, a water soluble polysaccharide comprising mannose and glucose in a molar ratio of 1.6:1 and joined by beta-1,4 glucosidic linkages.

In one embodiment, the hydrocolloid material of the edible compositions disclosed herein comprises a cellulose derivative. In one such embodiment, the cellulose derivative may comprise microcrystalline cellulose and/or sodium carboxymethyl cellulose.

In one embodiment, the hydrocolloid material of the edible compositions disclosed herein comprises an alginate. In one such embodiment, the hydrocolloid material comprises sodium alginate.

In one embodiment, the hydrocolloid material of the edible compositions disclosed herein comprises one or more of: konjac gum, microcrystalline cellulose, sodium carboxymethyl cellulose, and sodium alginate. In one embodiment, the hydrocolloid material of the edible compositions disclosed herein comprises each of: konjac gum, microcrystalline cellulose, sodium carboxymethyl cellulose, and sodium alginate.

In one embodiment, the hydrocolloid material comprise a first hydrocolloid composition comprising one or more of konjac gum, microcrystalline cellulose, and sodium carboxymethyl cellulose. In one embodiment, the first hydrocolloid composition comprises about 30 wt. % to about 60 wt. % of konjac gum, about 7 wt. % to about 13 wt. % microcrystalline methylcellulose, about 7 wt. % to about 13 wt. % modified starch, about 15 wt. % to about 40 wt. % native starch, and about 0.5 wt. % to about 1.5 wt. % of sodium carboxymethylcellulose, wherein the weight percentages are based on the total weight of the first hydrocolloid composition.

In one embodiment, the hydrocolloid material comprises a second hydrocolloid composition comprising sodium alginate.

In one embodiment, the hydrocolloid material comprises a first hydrocolloid material comprising konjac gum, microcrystalline cellulose, and sodium carboxymethyl cellulose, and a second hydrocolloid composition comprising sodium alginate, wherein, wherein the weight ratio of the first hydrocolloid composition to the second hydrocolloid composition is from about 5:1 to about 1:5, about 4.5:1 to about 1:4.5, about 4:1 to about 1:4, about 3.5:1 to about 1:3.5, about 3:1 to about 1:3, about 2.5:1 to about 1:2.5, about 2:1 to about 1:2, about 1.5:1 to about 1:1.5, or about 1:1. In one embodiment, the weight ratio of the first hydrocolloid composition (comprising konjac gum, microcrystalline cellulose, and sodium carboxymethyl cellulose) to the second hydrocolloid composition (comprising sodium alginate) is about 2.5:1.

In one embodiment, the edible compositions disclosed herein comprise about 2.48 wt. % of the first hydrocolloid composition (comprising konjac gum, microcrystalline cellulose, and sodium carboxymethyl cellulose), and about 0.99 wt. % of the second hydrocolloid composition (comprising sodium alginate), wherein the weight percentages are based on the total weight of the edible composition.

In one particular embodiment, the first hydrocolloid composition is Seagel® XP 3428, and the second hydrocolloid composition is Protanal® RF 6650.

In one embodiment, the edible compositions disclosed herein comprise about 0.5 wt. % to about 10 wt. %, about 1 wt. % to about 8 wt. %, about 2 wt. % to about 6 wt. %, about 2.5 wt. % to about 5 wt. %, or about 3 wt. % to about 4 wt. % of the hydrocolloid material (weight percentages are based on the total weight of the edible composition), wherein the hydrocolloid material comprises sodium alginate. In one embodiment, the edible compositions disclosed herein comprise about 1 wt. % to about 8 wt. %, about 2 wt. % to about 6 wt. %, about 2.5 wt. % to about 5 wt. %, or about 3 wt. % to about 4 wt. % of the hydrocolloid material (weight percentages are based on the total weight of the edible composition), wherein the hydrocolloid material consists of sodium alginate.

In one embodiment, the edible composition disclosed herein comprise sodium alginate in an amount of about 3.9 wt. % based on the total weight of the edible composition.

In one embodiment, including but not limited to those in which the edible compositions disclosed herein comprise sodium alginate, said compositions may include none (0 wt. % based on the total weight of the edible composition) or substantially none (e.g., less than about 1 wt. %, preferably less than about 0.01 wt. %, and more preferably less than about 0.001 wt. % based on the total weight of the edible composition) of the following: gellan gum (e.g., low acyl gellan gum or high acyl gellan gum), agar, alginate other than sodium alginate, carrageenan, cassia gum, cellulose gum, curdlan gum, guar gum, cellulose derivatives such as hydroxypropyl cellulose, hdyroxypropylmethyl cellulose, or carboxymethyl cellulose, konjac, locust bean gum, pectin, xanthan gum, combinations thereof, and other hydrocolloid(s) found in conventional edible compositions as would be apparent to skilled artisans upon reading the present disclosure.

Protein Material(s)

The edible compositions disclosed herein comprise at least one protein material, in one embodiment. The protein material may be a plant protein derived from amaranth, arrowroot, barley, buckwheat, canola, cassava, chickpea, corn, kamut, lentil, lupin, millet, oat, pea, peanut, potato, quinoa, rice, rye, sorghum, soy, sunflower, tapioca, triticale, wheat, combinations thereof, etc. In one embodiment, the protein material is derived from soy. In one embodiment, the protein material may comprise two or more (e.g., 2, 3, 4, 5, 6, etc.) different proteins (e.g., proteins derived from different plants).

In one embodiment, the protein material of the edible compositions disclosed herein comprises protein concentrate with a minimum protein content of about 70 wt. % (based on the total weight of the protein) on a moisture-free basis, or a protein isolate with a minimum protein content of about 80 wt. % (based on the total weight of the protein) on a moisture free-basis. In one embodiment, the protein material comprises a protein isolate. In one embodiment, the protein material comprises a soy concentrate. In one embodiment, the protein material comprises a soy isolate.

In one embodiment, the protein material of the edible compositions disclosed herein is selected from a soy protein isolate, a soy protein concentrate, a pea protein isolate, a pea protein concentrate, a rice protein isolate, a rice protein concentrate, a potato protein isolate, a potato protein concentrate, a chick-pea protein isolate, a chick-pea protein concentrate, an algal isolate, an algal concentrate, or combinations thereof. In one embodiment, the protein material of the edible compositions disclosed herein is soy protein isolate, soy protein concentrate, or combinations thereof

In one embodiment, the total amount of the protein material present in the edible compositions disclosed herein is from about 0.1 wt. % to about 30 wt. % based on the total weight of the edible composition. In particular embodiments, the total amount of the protein material is from about 0.5 wt. % to about 30 wt. %, about 1 wt. % to about 30 wt. %, about 3 wt. % to about 30 wt. %, about 6 wt. % to about 30 wt. %, about 10 wt. % to about 30 wt. %, about 15 wt. % to about 30 wt. %, about 20 wt. % to about 30 wt. %, about 25 wt. % to about 30 wt. %, about 0.1 wt. % to about 20 wt. %, about 0.5 wt. % to about 20 wt. %, about 1 wt. % to about 20 wt. %, about 3 wt. % to about 20 wt. %, about 6 wt. % to about 20 wt. %, about 10 wt. % to about 20 wt. %, about 15 wt. % to about 20 wt. %, about 0.1 wt. % to about 15 wt. %, about 0.5 wt. % to about 15 wt. %, about 1 wt. % to about 15 wt. %, about 3 wt. % to about 15 wt. %, about 6 wt. % to about 30 wt. %, about 10 wt. % to about 15 wt. %, about 13 wt. % to about 15 wt. %, about 0.1 wt. % to about 10 wt. %, about 0.5 wt. % to about 10 wt. %, about 1 wt. % to about 10 wt. %, about 3 wt. % to about 10 wt. %, about 6 wt. % to about 10 wt. %, about 8 wt. % to about 10 wt. %, about 0.1 wt. % to about 8 wt. %, about 0.5 wt. % to about 8 wt. %, about 1 wt. % to about 8 wt. %, about 3 wt. % to about 8 wt. %, about 6 wt. % to about 8 wt. %, about 0.1 wt. % to about 6 wt. %, about 0.5 wt. % to about 6 wt. %, about 1 wt. % to about 6 wt. %, or about 3 wt. % to about 6 wt. % based on the total weight of the edible composition.

In one embodiment, the total amount of the protein material is about 0.1 wt. %, 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, about 6.5 wt. %, about 8 wt. %, about 10 wt. %, about 15 wt. %, about 20 wt. %, about 25 wt. %, or about 30 wt. % based on the total weight of the edible composition.

In one embodiment, the edible compositions disclosed herein comprise soy isolate in an amount ranging from about 0.1 wt. % to about 30 wt. % based on the total weight of the edible composition. In one embodiment, the edible compositions disclosed herein comprise soy isolate in an amount of about 6.80 wt. % based on the total weight of the edible composition. In another embodiment, the edible compositions disclosed herein comprise soy isolate in an amount of about 10 wt. % of based on the total weight of the edible composition.

In one embodiment, the edible compositions disclosed herein comprise about 0.1 wt. % to about 30 wt. %, about 5 wt. % to about 20 wt. %, or about 8 wt. % to about 15 wt. % of the protein material (weight percentages based on the total weight of the edible composition), wherein the protein material comprises soy protein concentrate. In one embodiment, the edible compositions disclosed herein comprise about 0.1 wt. % to about 30 wt. %, about 5 wt. % to about 20 wt. %, or about 8 wt. % to about 15 wt. % of the protein material (weight percentages based on the total weight of the edible composition), wherein the protein material consists of soy protein concentrate.

In one embodiment, the edible compositions disclosed herein comprise soy protein concentrate in an amount of about 72.5 wt. % based on the total weight of the edible composition.

Flavoring Agent(s)

The edible compositions disclosed herein comprise one or more flavoring agents, in one embodiment. At least one of the one or more flavoring agents may impart a shrimp-like flavor to the edible compositions disclosed herein.

In one embodiment, at least one of the one or more flavoring agents is an algal extract that is consumed by shrimp in their wild habitat, rather than a synthetic compound as commonly used in conventional edible products. In one embodiment, this at least one flavoring agent comprises an algal extract from Haematococcus pluvialis. In one embodiment, such an algal extract comprises astaxanthin. Astaxanthin is a particularly suitable flavoring agent, as it not only imparts the desired shrimp-like flavor to the edible compositions disclosed herein, but also imparts a red or substantially red color thereto, thereby mimicking the flavor and appearance (e.g., the red or red-like colored streaks) of wild-caught or farmed shrimp.

In one embodiment, at least one of the one or more flavoring agents is an algal extract in the form of an oil. In one embodiment, such an algal oil may comprise a substantially minimal amount of saturated fat. For instance, in some embodiments, the algal oil may comprise no more than about 4 wt. % of saturated fat based on the total weight of the fatty acids present in the algal extract. In some embodiment, the algal oil may comprise about 4 wt. % of saturated fat, about 2 wt. % of polyunsaturated fat, and about 93 wt. % of oleic acid (monounsaturated fat), wherein the aforementioned weight percentages are based on the fatty acid content of the algal extract. In one embodiment, the algal oil may be AlgalWise® algae oil, e.g., as produced by TerraVia.

In one embodiment, at least one of the one or more flavoring agents is a commercially available shrimp savory flavor agent, e.g., from T. Hasegawa, Innova Flavors, etc., and which does not include astaxanthin or the aforementioned algae oil.

In one embodiment, the edible compositions disclosed herein comprise two or more (e.g., 2, 3, 4, 5, 6, etc.) different flavoring agents, wherein each flavoring agent is a different algal extract or algal oil.

In one embodiment, the edible compositions disclosed herein comprise at least one algal extract or algal oil, in combination with at least one additional vegan and natural flavoring agent (such as a commercially available shrimp savory flavor agent, e.g., from T. Hasegawa, Innova Flavors, etc.).

In one embodiment, the one or more flavoring agents may impart an additional flavor in addition to the shrimp or shrimp-like flavor. For instance, in one embodiment, the one or more flavoring agents may be included in the edible compositions disclosed herein to produce a sriracha shrimp flavor, a garlic shrimp flavor, etc.

In one embodiment, the total amount of flavoring agent present in the edible compositions disclosed herein is from about 0.0001 wt. % to about 5 wt. % based on the total weight of the edible composition. In one embodiment, the total amount of the flavoring agent is from about 0.001 wt. % to about 5 wt. %, about 0.01 wt. % to about 5 wt. %, about 0.1 wt. % to about 5 wt. %, about 1.0 wt. % to about 5 wt. %, about 1.5 wt. % to about 5 wt. %, about 2.0 wt. % to about 5 wt. %, about 2.5 wt. % to about 5 wt. %, about 3 wt. % to about 5 wt. %, about 3.5 wt. % to about 5 wt. %, about 4 wt. % to about 5 wt. %, about 4.5 wt. % to about 5 wt. %, about 0.0001 wt. % to about 4 wt. %, from about 0.001 wt. % to about 4 wt. %, about 0.01 wt. % to about 4 wt. %, about 0.1 wt. % to about 4 wt. %, about 1.0 wt. % to about 4 wt. %, about 1.5 wt. % to about 4 wt. %, about 2.0 wt. % to about 4 wt. %, about 2.5 wt. % to about 4 wt. %, about 3 wt. % to about 4 wt. %, about 3.5 wt. % to about 4 wt. %, from about 0.0001 wt. % to about 3 wt. %, about 0.001 wt. % to about 3 wt. %, about 0.01 wt. % to about 3 wt. %, about 0.1 wt. % to about 3 wt. %, about 1.0 wt. % to about 3 wt. %, about 1.5 wt. % to about 3 wt. %, about 2.0 wt. % to about 3 wt. %, about 2.5 wt. % to about 3 wt. %, from about 0.0001 wt. % to about 2 wt. %, about 0.001 wt. % to about 2 wt. %, about 0.01 wt. % to about 2 wt. %, about 0.1 wt. % to about 2 wt. %, about 1.0 wt. % to about 2 wt. %, about 1.5 wt. % to about 2 wt. %, about 0.0001 wt. % to about 1 wt. %, about 0.0005 wt. % to about 1 wt. %, about 0.001 wt. % to about 1 wt. %, about 0.005 wt. % to about 1 wt. %, about 0.01 wt. % to about 1 wt. %, about 0.05 wt. % to about 1 wt. %, about 0.1 wt. % to about 1 wt. %, about 0.5 wt. % to about 1 wt. %, about 0.0001 wt. % to about 0.5 wt. %, about 0.001 wt. % to about 0.5 wt. %, about 0.005 wt. % to about 0.5 wt. %, about 0.01 wt. % to about 0.5 wt. %, about 0.05 wt. % to about 0.5 wt. %, about 0.1 wt. % to about 0.5 wt. %, about 0.0001 wt. % to about 0.1 wt. %, about 0.0005 wt. % to about 0.1 wt. %, about 0.001 wt. % to about 0.1 wt. %, about 0.005 wt. % to about 0.1 wt. %, about 0.01 wt. % to about 0.1 wt. %, or about 0.05 wt. % to about 0.1 wt. % based on the total weight of the edible composition.

In one embodiment, the total amount of flavoring agent is about 0.0001 wt. %, about 0.0002 wt. %, about 0.0004 wt. %, about 0.0006 wt. %, about 0.0008 wt. %, about 0.001 wt. %, about 0.002 wt. %, about 0.004 wt. %, about 0.006 wt. %, about 0.008 wt. %, about 0.01 wt. %, about 0.02 wt. %, about 0.04 wt. %, about 0.06 wt. %, about 0.08 wt. %, about 0.1 wt. %, about 0.2 wt. %, about 0.4 wt. %, about 0.6 wt. %, about 0.8 wt. %, about 1.0 wt. %, about 1.2 wt. %, about 1.4 wt. %, about 1.6 wt. %, about 1.8 wt. %, about 2.0 wt. %, about 2.2 wt. %, about 2.4 wt. %, about 2.6 wt. %, about 2.8 wt. %, about 3.0 wt. %, about 3.2 wt. %, about 3.4 wt. %, about 3.6 wt. %, about 3.8 wt. %, about 4.0 wt. %, about 4.2 wt. %, about 4.4 wt. %, about 4.6 wt. %, about 4.8 wt. %, or about 5.0 wt. % based on the total weight of the edible composition.

In one embodiment, the edible compositions disclosed herein comprise astaxanthin in an amount ranging from about 0.0001 wt. % to about 0.1 wt. % based on the total weight of the edible composition. In one embodiment, the edible compositions disclosed herein comprise astaxanthin in an amount of about 0.05 wt. % based on the total weight of the edible composition.

In one embodiment, the edible compositions disclosed herein comprise an algal oil in an amount ranging from about 0.0001 wt. % to about 5 wt. % based on the total weight of the edible composition. In one embodiment, the edible compositions disclosed herein comprise an algal oil in an amount of about 2.5 wt. % based on the total weight of the edible composition.

In one embodiment, the edible compositions disclosed herein comprise one or more flavoring agents in an amount ranging from 0.0001 wt. % to about 5 wt. %, about 0.001 wt. % to about 3 wt. %, about 0.1 wt. % to about 2 wt. %, or about 0.5 wt. % to about 1 wt. % (weight percentages are based on the total weight of the edible composition), wherein at least one of the one or more flavoring agents is a commercially available shrimp savory flavor agent. In one embodiment, the edible compositions disclosed herein comprise one or more commercially available shrimp savory flavoring agents in an amount of about 0.8 wt. % based on the total weight of the edible composition.

It is of note that the flavoring agents in the edible compositions disclosed herein are not limited to shrimp or shrimp-like flavors. For instance, in some embodiments, the one or more flavoring agents included in the edible compositions disclosed herein may impart the flavor of a lobster/langoustine, a desired fish, a scallop, crab, etc.

Salt(s)

The edible compositions disclosed herein comprise at least one salt, in one embodiment. Suitable salts may include, but are not limited to calcium chloride, tricalcium phosphate, sodium carbonate, potassium carbonate, ammonium carbonate, magnesium carbonate, hydrochloric acid, potassium chloride, ammonium chloride, magnesium chloride, sodium chloride, stannous chloride, sodium sulfate, potassium sulfate, calcium sulfate, ammonium sulfate, magnesium sulfate, copper sulfate, aluminium sulfate, aluminium sodium sulfate, aluminium potassium sulfate, aluminium ammonium sulfate, sodium hydroxide, potassium hydroxide, calcium hydroxide, ammonium hydroxide, magnesium hydroxide, calcium oxide, magnesium oxide, sodium ferrocyanide, potassium ferrocyanide, calcium ferrocyanide, dicalcium diphosphate, sodium aluminium phosphate, magnesium stearate, calcium stearate, sodium gluconate, potassium gluconate, calcium gluconate, ferrous gluconate, calcium lactate, ferrous lactate, acid salts such as sodium citrate, and combinations thereof.

In one embodiment, the at least one salt is sea salt.

In one embodiment, the edible composition comprises calcium chloride. In one embodiment, the edible compositions disclosed herein comprise one or more of: calcium chloride, sodium chloride, calcium lactate, calcium hydroxide, and sodium citrate. In one embodiment, the edible compositions disclosed herein comprise each of calcium chloride, sodium chloride, calcium lactate, calcium hydroxide, and sodium citrate.

In one embodiment, the edible compositions disclosed herein may include none (0 wt. % based on the total weight of the edible composition) or substantially none (e.g., less than about 1 wt. %, preferably less than about 0.01 wt. %, and more preferably less than about 0.001 wt. % based on the total weight of the edible composition) of the following: tricalcium phosphate, sodium carbonate, potassium carbonate, ammonium carbonate, magnesium carbonate, hydrochloric acid, potassium chloride, ammonium chloride, magnesium chloride, sodium chloride, stannous chloride, sodium sulfate, potassium sulfate, calcium sulfate, ammonium sulfate, magnesium sulfate, copper sulfate, aluminium sulfate, aluminium sodium sulfate, aluminium potassium sulfate, aluminium ammonium sulfate, sodium hydroxide, potassium hydroxide, calcium hydroxide, ammonium hydroxide, magnesium hydroxide, calcium oxide, magnesium oxide, sodium ferrocyanide, potassium ferrocyanide, calcium ferrocyanide, dicalcium diphosphate, sodium aluminium phosphate, magnesium stearate, calcium stearate, sodium gluconate, potassium gluconate, calcium gluconate, ferrous gluconate, ferrous lactate, combinations thereof, and other salt(s) found in conventional edible compositions as would be apparent to skilled artisans upon reading the present disclosure.

In one embodiment, the total salt content in the edible compositions disclosed herein is from about 0.001 wt. % to about 3 wt. %, about 0.005 wt. % to about 3 wt. %, about 0.01 wt. % to about 3 wt. %, about 0.05 wt. % to about 3 wt. %, about 0.1 wt. % to about 3 wt. %, about 0.5 wt. % to about 3 wt. %, about 1 wt. % to about 3 wt. %, about 2 wt. % to about 3 wt. %, about 0.001 wt. % to about 2 wt. %, about 0.005 wt. % to about 2 wt. %, about 0.01 wt. % to about 2 wt. %, about 0.05 wt. % to about 2 wt. %, about 0.1 wt. % to about 2 wt. %, about 0.5 wt. % to about 2 wt. %, about 1 wt. % to about 2 wt. %, about 0.001 wt. % to about 1 wt. %, about 0.005 wt. % to about 1 wt. %, about 0.01 wt. % to about 1 wt. %, about 0.05 wt. % to about 1 wt. %, about 0.1 wt. % to about 1 wt. %, about 0.5 wt. % to about 1 wt. %, about 0.001 wt. % to about 0.5 wt. %, about 0.005 wt. % to about 0.5 wt. %, or about 0.01 wt. % to about 0.5 wt. % based on the total weight of the edible composition.

In one embodiment, the total salt content is about 0.001 wt. %, about 0.002 wt. %, about 0.004 wt. %, about 0.006 wt. %, about 0.008 wt. %, about 0.01 wt. %, about 0.02 wt. %, about 0.04 wt. %, about 0.06 wt. %, about 0.08 wt. %, about 0.1 wt. %, about 0.5 wt. %, about 1 wt. %, about 1.5 wt. % about 2.0 wt. %, about 2.5 wt. %, or about 3 wt. % based on the total weight of the edible composition. In one embodiment, the total salt content is about 2.0 wt. % based on the total weight of the edible composition.

In one embodiment, the edible compositions disclosed herein comprise calcium chloride in an amount ranging from about 0.001 wt. % to about 3 wt. % based on the total weight of the edible composition. In one embodiment, the edible compositions disclosed herein comprise calcium chloride in an amount of about 0.02 wt. % based on the total weight of the edible composition.

In one embodiment, the edible compositions disclosed herein comprise from about from about 0.001 wt. % to about 3 wt. % of sodium chloride; from about from about 0.0001 wt. % to about 1 wt. % of calcium lactate; from about 0.0001 wt. % to about 1 wt. % of calcium hydroxide, and from about 0.0001 wt. % to about 1 wt. % of sodium citrate, wherein the weight percentages are based on the total weight of the edible composition. In one embodiment, the edible compositions disclosed herein comprise about 0.5 wt. % of sodium chloride, about 0.13 wt. % of calcium lactate, about 0.07 wt. % of sodium citrate, and about 0.03 wt. % of calcium hydroxide, wherein the weight percentages are based on the total weight of the edible composition.

In one embodiment, the edible compositions disclosed herein comprise sea salt in an amount ranging from about 0.001 wt. % to about 3 wt. %, about 0.1 wt. % to about 2 wt. %, or about 0.5 wt. % to about 1.5 wt. % based on the total weight of the edible composition. In one embodiment, the edible compositions disclosed herein comprise sea salt in an amount of about 1.15 wt. % based on the total weight of the edible composition.

Oil(s)

The edible compositions disclosed herein comprise one or more optional oils, in one embodiment. It is of note that these one or more optional oils are to be distinguished from the algae oil discussed previously. In one embodiment, the one or more optional oils may be derived from plant sources such as avocado, cocoa, coconut, corn, cottonseed, flax, olive, palm, peanut, rapeseed, safflower, soya, sunflower, combinations thereof, etc. In one embodiment, the edible compositions disclosed herein comprise olive oil, particularly extra virgin olive oil.

In one embodiment, the edible compositions disclosed herein comprise an oil selected from algal/algae oil, avocado oil, olive oil, and combinations thereof. In one embodiment, the edible compositions disclosed herein comprises an alga/algae oil.

In one embodiment, including but not limited to those in which the edible compositions disclosed herein comprise extra virgin olive oil, said compositions may include none (0 wt. % based on the total weight of the edible composition) or substantially none (e.g., less than about 1 wt. %, preferably less than about 0.01 wt. %, and more preferably less than about 0.001 wt. % based on the total weight of the edible composition) of the following: avocado oil, sunflower oil, safflower oil, palm oil, coconut oil, combinations thereof, or other oil(s) found in conventional edible compositions as would be apparent to skilled artisans upon reading the present disclosure.

In one embodiment, the total amount of the optional oil(s) in the edible compositions disclosed herein is from about 0.1 wt. % to about 10 wt. %, about 0.2 wt. % to about 10 wt. %, about 0.4 wt. % to about 10 wt. %, about 0.6 wt. % to about 10 wt. %, about 0.8 wt. % to about 10 wt. %, about 1 wt. % to about 10 wt. %, about 2 wt. % to about 10 wt. %, about 4 wt. % to about 10 wt. %, about 6 wt. % to about 10 wt. %, about 8 wt. % to about 10 wt. %, 0.1 wt. % to about 8 wt. %, about 0.2 wt. % to about 8 wt. %, about 0.4 wt. % to about 8 wt. %, about 0.6 wt. % to about 8 wt. %, about 0.8 wt. % to about 8 wt. %, about 1 wt. % to about 8 wt. %, about 2 wt. % to about 8 wt. %, about 4 wt. % to about 8 wt. %, about 6 wt. % to about 8 wt. %, 0.1 wt. % to about 5 wt. %, about 0.2 wt. % to about 5 wt. %, about 0.4 wt. % to about 5 wt. %, about 0.6 wt. % to about 5 wt. %, about 0.8 wt. % to about 5 wt. %, about 1 wt. % to about 5 wt. %, about 2 wt. % to about 5 wt. %, about 4 wt. % to about 5 wt. %, 0.1 wt. % to about 2 wt. %, about 0.2 wt. % to about 2 wt. %, about 0.4 wt. % to about 2 wt. %, about 0.6 wt. % to about 2 wt. %, about 0.8 wt. % to about 2 wt. %, or about 1 wt. % to about 2 wt. % based on the total weight of the edible composition.

In one embodiment, the total amount of the optional oil(s) disclosed herein is about 0.1 wt. %, about 0.2 wt. %, about 0.4 wt. %, about 0.6 wt. %, about 0.8 wt. %, about 1 wt. %, about 2 wt. %, about 3 wt. %, about 4 wt. %, about 5 wt. %, about 6 wt. %, about 7 wt. %, about 8 wt. %, about 9 wt. %, or about 10 wt. % based on the total weight of the edible composition. In one embodiment, the total amount of the optional oil(s) disclosed herein is about 0.63 wt. % based on the total weight of the edible composition.

In one embodiment, the edible compositions disclosed herein comprise algal/algae oil in an amount ranging from about 1 wt. % to about 7 wt. %, about 1.5 wt. % to about 5 wt. %, or about 2 wt. % to about 3 wt. % based on the total weight of the edible composition. In one embodiment, the edible compositions disclosed herein comprise algal/algae oil in an amount of about 2.7 wt. % based on the total weight of the edible composition.

Water

The edible compositions disclosed herein comprise water, in one embodiment. In one embodiment, a total amount of the water present in the disclosed edible compositions is from about 50 wt. % to about 95 wt. % based on the total weight of the edible composition. In one embodiment, the total water content is from about 55 wt. % to about 95 wt. %, about 60 wt. % to about 95 wt. %, about 65 wt. % to about 95 wt. %, about 70 wt. % to about 95 wt. %, about 75 wt. % to about 95 wt. %, about 80 wt. % to about 95 wt. %, about 85 wt. % to about 95 wt. %, about 90 wt. % to about 95 wt. %, about 50 wt. % to about 85 wt. %, about 55 wt. % to about 85 wt. %, about 60 wt. % to about 85 wt. %, about 65 wt. % to about 85 wt. %, about 70 wt. % to about 85 wt. %, about 75 wt. % to about 85 wt. %, about 80 wt. % to about 85 wt. %, about 50 wt. % to about 75 wt. %, about 55 wt. % to about 75 wt. %, about 60 wt. % to about 75 wt. %, about 65 wt. % to about 75 wt. %, about 70 wt. % to about 75 wt. %, about 50 wt. % to about 65 wt. %, about 55 wt. % to about 65 wt. %, about 60 wt. % to about 65 wt. %, about 50 wt. % to about 65 wt. %, or about 55 wt. % to about 65 wt. % based on the total weight of the edible composition.

In one embodiment, the total water content is about 50 wt. %, 52 wt. %, 54 wt. %, 56 wt. %, 58 wt. %, 60 wt. %, 62 wt. %, 64 wt. %, 66 wt. %, 68 wt. %, 70 wt. %, 72 wt. %, 74 wt. %, 76 wt. %, 78 wt. %, 80 wt. %, 82 wt. %, 84 wt. %, 86 wt. %, 88 wt. %, 90 wt. %, 92 wt. %, or 94 wt. % based on the total weight of the edible composition. In one embodiment, the total water content is about 87.65 wt. % based on the total weight of the edible composition. In one embodiment, the total water content is about 79.4 wt. % based on the total weight of the edible composition. In one embodiment, the total water content is about 79.0 wt. % based on the total weight of the edible composition.

In one embodiment, the water included in the edible compositions disclosed herein is deionized water. In one embodiment, the water included in the edible compositions disclosed herein is sea water.

Additional Ingredients

The edible compositions disclosed herein may optionally comprise one or more additional ingredients, in one embodiment. These additional ingredients may include, but are not limited to, sugars, acids, preservatives, color additives, colorants, emulsifiers, antioxidants, dietary fiber, etc.

For instance, in one embodiment, the edible compositions disclosed herein may comprise one or more additional sugars. According to one such embodiment, the additional sugar may be white, granulated sugar as commercially available.

In one embodiment, the total amount of the additional sugar(s) in the edible compositions disclosed herein may be from about 0.1 wt % to about 6 wt. %, about 0.2 wt % to about 6 wt. %, about 0.4 wt % to about 6 wt. %, about 0.6 wt % to about 6 wt. %, about 0.8 wt % to about 6 wt. %, about 1 wt % to about 6 wt. %, about 2 wt % to about 6 wt. %, about 4 wt. % to about 6 wt. %, about 0.1 wt % to about 4 wt. %, about 0.2 wt % to about 4 wt. %, about 0.4 wt % to about 4 wt. %, about 0.6 wt % to about 4 wt. %, about 0.8 wt % to about 4 wt. %, about 1 wt % to about 4 wt. %, about 2 wt % to about 4 wt. %, about 0.1 wt % to about 2 wt. %, about 0.2 wt % to about 2 wt. %, about 0.4 wt % to about 2 wt. %, about 0.6 wt % to about 2 wt. %, about 0.8 wt % to about 2 wt. %, about 1 wt % to about 2 wt. %, about 0.1 wt % to about 1 wt. %, about 0.2 wt % to about 1 wt. %, about 0.4 wt % to about 1 wt. %, about 0.6 wt % to about 1 wt. %, or about 0.8 wt. % to about 1 wt. %. In one embodiment, the total amount of the additional sugars may be about 0.1 wt. %, about 0.2 wt. %, about 0.4 wt. %, about 0.6 wt. %, about 0.8 wt. %, about 1 wt. %, about 2 wt. %, about 3 wt. %, about 4 wt. %, about 5 wt. %, or about 6 wt. % based on the total weight of the edible composition. In one embodiment, the total amount of the additional sugar(s) may be about 0.97 wt. % based on the total weight of the edible composition.

In one embodiment, the edible compositions disclosed herein may comprise one or more optional emulsifiers including, but not limited to, soy lecithin, calcium stearoyl di laciate, polyglycerol ester, sorbitan ester, polypropylene glycol ester, sugar ester, monoglyceride, acetylated monoglyceride, lactylated monoglyceride, combinations thereof, etc. However, in one embodiment, the disclosed edible compositions may include none (0 wt. % based on the total weight of the edible composition) or substantially none (e.g., less than about 1 wt. %, preferably less than about 0.01 wt. %, and more preferably less than about 0.001 wt. % based on the total weight of the edible composition) of the aforementioned optional emulsifiers.

In one embodiment, the edible compositions disclosed herein may comprise one or more optional anti-caking agents including, but not limited to, sodium silicate, silicon dioxide, calcium silicate, sodium aluminium silicate, sulfuric acid, potassium aluminium silicate, aluminium calcium silicate, bentonite, kaolin, stearic acid, gluconic acid, glucono delta-lactone, combinations thereof, etc. However, in one embodiment, the disclosed edible compositions may include none (0 wt. % based on the total weight of the edible composition) or substantially none (e.g., less than about 1 wt. %, preferably less than about 0.01 wt. %, and more preferably less than about 0.001 wt. % based on the total weight of the edible composition) of the aforementioned optional anti-caking agents.

In one embodiment, the edible compositions disclosed herein may comprise one or more optional acids including, but not limited, citric acid, malic acid, tartric acid, acetic acid, oxalic acid, tannic acid, butyric acid, combinations thereof, etc. However, in one embodiment, the disclosed edible compositions may include none (0 wt. % based on the total weight of the edible composition) or substantially none (e.g., less than about 1 wt. %, preferably less than about 0.01 wt. %, and more preferably less than about 0.001 wt. % based on the total weight of the edible composition) of the aforementioned optional acids.

In one embodiment, the edible compositions disclosed herein may comprise one or more optional preservatives selected from the group consisting of benzoate, benzoic acid, nitrite, sulfur dioxide, sodium sorbate, butylated hydroxyanisole, sodium nitrate, sodium benzoate, ethylenediamine tetraacetic acid (EDTA), combinations thereof, etc. However, in one embodiment, the disclosed edible compositions may include none (0 wt. % based on the total weight of the edible composition) or substantially none (e.g., less than about 1 wt. %, preferably less than about 0.01 wt. %, and more preferably less than about 0.001 wt. % based on the total weight of the edible composition) of the aforementioned optional preservatives.

In one embodiment, the edible compositions disclosed herein include from 0 wt. % to less than about 1 wt. %, preferably less than about 0.01 wt. %, and more preferably less than 0.001 wt. % of starch based on the total weight of the edible composition. In one embodiment, the edible compositions disclosed herein include from 0 wt. % to less than about 1 wt. %, preferably less than about 0.01 wt. %, and more preferably less than 0.0001 wt. % of gluten based on the total weight of the edible composition.

In one embodiment, the edible compositions disclosed herein may comprise one or more optional coloring agents configured to impart a red or substantially red color thereto. Suitable coloring agents may include, but are not limited to, lycopene, beta-carotene, paprika, combinations thereof, etc. In one embodiment, the total amount of the coloring agent(s) may be from about 0.001 wt. % to about 2 wt. %, about 0.01 wt. % to about 2 wt. %, about 0.1 wt. % to about 2 wt. %, about 1 wt. % to about 2 wt. %, about 1.5 wt. % to about 2 wt. %, about 0.001 wt. % to about 1.5 wt. %, about 0.01 wt. % to about 1.5 wt. %, about 0.1 wt. % to about 1.5 wt. %, about 1 wt. % to about 1.5 wt. %, about 0.001 wt. % to about 1 wt. %, about 0.01 wt. % to about 1 wt. %, about 0.1 wt. % to about 1 wt. %, about 0.001 wt. % to about 0.5 wt. %, about 0.01 wt. % to about 0.5 wt. %, about 0.1 wt. % to about 0.5 wt. %, about 0.001 wt. % to about 0.1 wt. %, or about 0.01 wt. % to about 0.1 based on the total weight of the edible composition. In one embodiment, the total amount of the coloring agent(s) may be about 0.001 wt. %, about 0.005 wt. %, about 0.01 wt. %, about 0.05 wt. %, about 0.1 wt. %, about 0.5 wt. %, about 1 wt. %, about 1.5 wt. % or about 2 wt. % based on the total weight of the edible composition. In one embodiment, the edible compositions disclosed herein may comprise lycopene in an amount of about 0.40 wt. % based on the total weight of the edible composition. In one embodiment, the edible compositions disclosed herein may comprise lycopene in an amount of about 0.10 wt. % based on the total weight of the edible composition.

However, in one embodiment, the disclosed edible compositions may include none (0 wt. % based on the total weight of the edible composition) or substantially none (e.g., less than about 1 wt. %, preferably less than about 0.01 wt. %, and more preferably less than about 0.001 wt. % based on the total weight of the edible composition) of the aforementioned optional coloring agents.

In one embodiment, the edible compositions disclosed herein may optionally comprise dietary fiber, such as bamboo fiber, in an amount from about 0.001 wt. % to about 3 wt. %, about 0.01 wt. % to about 3 wt. %, about 0.1 wt. % to about 3 wt. %, about 1 wt. % to about 3 wt. %, about 1.5 wt. % to about 3 wt. %, about 2 wt. % to about 3 wt. %, about 2.5 wt. % to about 3 wt. %, about 0.001 to about 2 wt. %, about 0.01 wt. % to about 2 wt. %, about 0.1 wt. % to about 2 wt. %, about 1 wt. % to about 2 wt. %, about 1.5 wt. % to about 2 wt. %, about 0.001 wt. % to about 1 wt. %, about 0.01 wt. % to about 1 wt. %, about 0.1 wt. % to about 1 wt. %, about 0.001 wt. % to about 0.1 wt. %, or about 0.01 wt. % to about 0.1 wt. % based on the total weight of the edible composition. In one embodiment, the edible compositions disclosed herein may optionally comprise dietary fiber, such as bamboo fiber, in an amount of about 0.001 wt. %, about 0.005 wt. %, about 0.01 wt. %, about 0.05 wt. %, about 0.1 wt. %, about 0.5 wt. %, about 1 wt. %, about 1.5 wt. %, about 2 wt. %, about 2.5 wt. % or about 3 wt. % based on the total weight of the edible composition.

In one embodiment, the edible compositions disclosed herein may optionally comprise dietary fiber in an amount from about 0.001 wt. % to about 3 wt. %, about 0.1 wt. % to about 2 wt. %, or about 0.5 wt. % to about 1.5 wt. % based on the total weight of the edible composition, wherein the dietary fiber is selected from bamboo fiber, citrus fiber, and combinations thereof. In one embodiment, the edible compositions disclosed herein comprise bamboo fiber in an amount of about 0.8 wt. % based on the total weight of the edible composition.

Organoleptic Properties

As discussed previously, the edible compositions disclosed herein mimic the organoleptic properties of seafood. Organoleptic properties include taste/flavor, appearance, texture, and odor, and are evaluated via established qualitative and quantitative methods. Such methods include, but are not limited to, sensory analysis performed by a qualified panel of experts and which conforms to USDA, FDA, ISO, EPA, AOAC, and/or AOCS requirements, gas chromatography, high performance liquid chromatography, etc.

In one embodiment, the edible compositions disclosed herein exhibit one or more organoleptic properties that are equivalent, or substantially equivalent, to those of wild-caught or farmed shrimp, as measured via known organoleptic testing methods. In particular, the edible compositions disclosed herein may have the flavor, odor, appearance, and texture, of wild-caught or farmed shrimp, yet comprise substantially no animal products or animal byproducts. For instance, in one embodiment, the edible compositions disclosed herein and wild-caught or farmed shrimp may have equivalent or substantially equivalent shear strength, elasticity, hardness, springiness, fracture point, etc.

In embodiments in which the texture of the edible compositions disclosed herein may be substantially the same as wild-caught or farmed shrimp, the texture of said compositions may be characterized as a high moisture extruded protein, where the fibers thereof are moist with an elastic chew and impart a shrimp flavor upon mastication thereof. Additionally, the flavor of such edible compositions may substantially mimic that of fresh wild-caught or farmed shrimp. As discussed herein, such shrimp-flavored edible compositions may also: have the shape of a shrimp (typically with no tail or head); have any desired size; and/or be subjected to any desired culinary process (e.g., grilling, baking, breading, frying, marinating, etc.). In embodiments in which the shrimp-flavored edible compositions are marinated and/or grilled, the compositions may also have additional flavors such as lemon, basil, teriyaki, garlic, etc. In embodiments in which the shrimp-flavored edible compositions are breaded or fried, the compositions may also have additional flavors such as that of Old Bay, buffalo flavor, sriracha flavor, etc. In some embodiments, the nutritional value of the shrimp-flavored edible compositions are comparable to that of conventional shrimp.

In embodiments in which the texture of the edible compositions disclosed herein may be substantially the same as crab (e.g., blue crab), the texture of said compositions may be characterized as a shredded, semi-firm protein (e.g., pea protein) with alginate fibers. As discussed herein, such crab-flavored edible compositions may also: have the shape of a crab claw, crab fillet/meat, crab cake, or crab stick; have any desired size; and/or be subjected to any desired culinary process (e.g., grilling, baking, breading, frying, marinating, etc.). In embodiments in which the crab-flavored edible compositions are marinated and/or grilled, the compositions may also have additional flavors such as lemon, basil, teriyaki, garlic, etc. In embodiments in which the crab-flavored edible compositions are breaded or fried, the compositions may also have additional flavors such as that of Old Bay, buffalo flavor, sriracha flavor, etc. In some embodiments, the nutritional value of the crab-flavored edible compositions are comparable to that of conventional blue crab.

In embodiments in which the texture of the edible compositions disclosed herein may be substantially the same as a cod/haddock fish fillet, the texture of said compositions may be characterized as soft, cohesive, and aligned faux muscle strands of a protein (e.g., a pea protein). As discussed herein, such cod/haddock-flavored edible compositions may also: have the shape of a cod/haddock fillet; have any desired size; and/or be subjected to any desired culinary process (e.g., grilling, baking, breading, frying, marinating, etc.). In some embodiments, the odor of the raw (un-cooked) cod/haddock-flavored edible compositions may be characterized as that of fresh oil, metallic, fresh-cut grass, earthy, and/or peppery. In some embodiments, the odor of cod/haddock-flavored edible compositions after cooking may be characterized as that of a weak scent of sweet, boiled milk, starchy, where said odors strengthen over time. In some embodiments, the cod/haddock-flavored edible compositions, after cooking, may have a texture that is dry and crumbly with short, tough fibers, and/or a flavor characterized as water, metallic, starchy, and which is not initially sweet but may develop sweetness over time. In embodiments in which the cod/haddock-flavored edible compositions are marinated and/or grilled, the compositions may also have additional flavors such as lemon, basil, teriyaki, garlic, etc. In embodiments in which the cod/haddock-flavored edible compositions are breaded or fried, the compositions may also have additional flavors such as that of Old Bay, buffalo flavor, sriracha flavor, etc. In some embodiments, the nutritional value of the cod/haddock-flavored edible compositions are comparable to that of conventional cod/haddock.

In embodiments in which the texture of the edible compositions disclosed herein may be substantially the same as a salmon fillet/steak, the texture of said compositions may be characterized as firm, moist, cohesive, aligned muscle strands of protein (e.g., a pea protein). In some embodiments, the nutritional value of the salmon-flavored edible compositions are comparable to that of wild-caught or farmed salmon. As discussed herein, such salmon-flavored edible compositions may also: have the shape of a salmon fillet/steak; have any desired size; and/or be subjected to any desired culinary process (e.g., grilling, baking, breading, frying, marinating, etc.). In some embodiments, the odor of the salmon-flavored edible compositions may be characterized as that of a mild marine salty smell, but does not have an overall “fishy” smell. In embodiments in which the salmon-flavored edible compositions are marinated and/or grilled, the compositions may also have additional flavors such as lemon, basil, teriyaki, garlic, etc. In embodiments in which the salmon-flavored edible compositions are breaded or fried, the compositions may also have additional flavors such as that of Old Bay, buffalo flavor, sriracha flavor, etc. In some embodiment, the color of the salmon-flavored edible compositions may be a deep red to vibrate coral to bright pink, and substantially mirror that of wild-caught of farmed salmon. In some embodiments, the nutritional value of the salmon-flavored edible compositions are comparable to that of conventional salmon.

In embodiments in which the texture of the edible compositions disclosed herein may be substantially the same as lobster/langoustine, the texture of said compositions may be characterized as a shredded, semi-firm protein (e.g., a pea protein) with alginate fibers. As discussed herein, such lobster/langoustine-flavored edible compositions may also: have the shape of a lobster/langoustine claw, meat, tail, shredded meat, lobster/langoustine cake, or any suitable desired anatomical and edible part of a lobster/langoustine; have any desired size; and/or be subjected to any desired culinary process (e.g., grilling, baking, breading, frying, marinating, etc.). In embodiments in which the lobster/langoustine -flavored edible compositions are marinated and/or grilled, the compositions may also have additional flavors such as lemon, basil, teriyaki, garlic, etc. In embodiments in which the lobster/langoustine -flavored edible compositions are breaded or fried, the compositions may also have additional flavors such as that of Old Bay, buffalo flavor, sriracha flavor, etc. In some embodiments, the nutritional value of the lobster/langoustine-flavored edible compositions are comparable to that of conventional lobster/langoustine without the cholesterol associated therewith.

In embodiments in which the texture of the edible compositions disclosed herein may be substantially the same as a scallop, the texture of said compositions may be similar to that of crab or lobster but more firm. As discussed herein, such scallop-flavored edible compositions may also: have any desired size; and/or be subjected to any desired culinary process (e.g., grilling, baking, breading, frying, marinating, etc.). In embodiments in which the scallop-flavored edible compositions are marinated and/or grilled, the compositions may also have additional flavors such as lemon, basil, teriyaki, garlic, etc. In embodiments in which the scallop -flavored edible compositions are breaded or fried, the compositions may also have additional flavors such as that of Old Bay, buffalo flavor, sriracha flavor, etc. In some embodiments, the nutritional value of the scallop -flavored edible compositions are comparable to that of conventional scallops.

Form/Shape

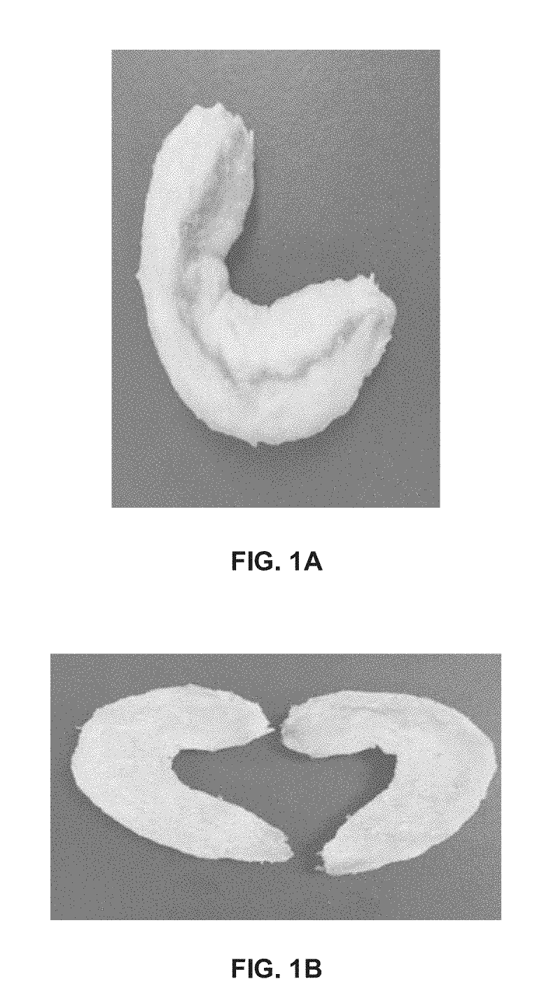

In one embodiment, the edible composition may be formed/molded into the characteristic crescent shape of a shrimp that has no head or tail, as shown in FIG. 1. The ultimate shape of the edible compositions disclosed herein, however, is not limited to that of a shrimp, but may take on the shape of a particular species of seafood, or any suitable shape envisioned by a skilled artisan upon reading the present disclosure. For instance suitable shapes for the edible compositions disclosed herein may include the shape of a shrimp, a lobster/langoustine, a scallop, a fish stick, a fish nugget, a fish fillet, a crab claw, a crab cake, crab stick, etc.

Preparation and Use

The aforementioned edible compositions may be prepared by the methods disclosed herein, and routine modifications thereof which will be apparent to skilled artisans upon reading the present disclosure. Conventional and well-known synthetic methods may also be used in lieu of, or in addition to, the methods presented herein. Moreover, if available, the starting materials for the preparation of the compositions disclosed herein may be purchased commercially or synthesized using known methods.

In one embodiment, a first method of making an edible composition, such as disclosed herein, comprises:
(i) combining at least one hydrocolloid material as disclosed herein, at least one protein material as disclosed herein, and water to form a first solution;
(ii) adding at least one oil as disclosed herein to the first solution after a predetermined amount of time has elapsed from combining the at least one hydrocolloid material, the at least one protein material and the water;
(iii) combining at least one additional sugar as disclosed herein, and at least one salt as disclosed herein to form a second solution;
(iv) heating the first and second solutions; and
(v) combining the heated first and second solutions to form the edible composition.

In one embodiment, the predetermined amount of time (i.e., the time elapsed between combining the at least one hydrocolloid, the at least one protein material, and water to form the first solution and the subsequent adding of the at least one oil to the first solution) may be in a range from about 15 minutes to about 1 hour. In one embodiment, the predetermined amount of time is about 15 minutes. The aforementioned time range (i.e., about 15 minutes to about 1 hour) is useful/important as it allows the at least one hydrocolloid and the at least one protein material to absorb an adequate amount of water before gelling occurs, according to one embodiment. For instance, addition of the at least one oil before about 15 minutes has elapsed may prevent the at least one hydrocolloid and the at least one protein material from absorbing enough water to properly gel.

In one embodiment, the first solution is heated to a temperature ranging from about 85° C. to about 100° C. In one embodiment, the first solution is heated to about 90° C. The first solution may be occasionally stirred during the heating thereof, in one embodiment. Further, upon heating the first solution to a temperature from about 85° C. to about 100° C., the first solution becomes viscous.

In one embodiment, the second solution is heated to a temperature ranging from about 60° C. to about 95° C. In one embodiment, the second solution is heated to about 85° C.

In one embodiment, the first method further comprises adding the edible composition to a mold having a predetermined shape (e.g., a shrimp or shrimp-like shape), and removing the edible composition from the mold, whereby the edible composition retains the predetermined shape of the mold when removed therefrom. In one embodiment, a flavoring agent and optional color additive(s) may be added to the edible composition having the predetermined shape by, for example, coating the flavoring agent and optional color additive(s) on the exterior surface of said composition. However, in one embodiment, a flavoring agent and optional color additive(s) may be added to the edible composition prior to the molding/shaping process.

In one embodiment, the optional color additive(s) may be added to one or more portions of the edible composition during the molding/shaping process. For instance, in one such embodiment, the color additive(s) may be coated/sprayed on one or more portions of the mold prior to addition of edible composition thereto. Accordingly, when the edible composition is added to the mold, the color additive(s) will be transferred to one or more portions of the composition.

In one embodiment, a second method of making an edible composition, such as disclosed herein, comprises:
(i) hydrating at least one protein material in water for a first predetermined time period;
(ii) combining a hydrocolloid material with the hydrated protein material to form a first mixture;
(iii) adding at least one additional sugar, a first salt, one or more flavoring agents, and bamboo fiber to the first mixture to form a second mixture;
(iv) adding a first solution comprising a second salt and water to the second mixture to form a third mixture; and
(v) depositing the third mixture in a second solution comprising a third salt and water for a second predetermined time period.

In one embodiment, the first predetermined time period and/or the second time period may each independently correspond to about 10 minutes to an hour. In one embodiment, the first time period may correspond to about 15 minutes, and/or the second predetermined time period may correspond to about 20 minutes.

In one embodiment, the first salt, the second salt, and the third salt may be the same or different from one another with respect to composition, amount thereof in the edible composition, etc. In one embodiment, the first salt comprises sodium chloride. In embodiment, the second salt comprises calcium lactate. In one embodiment, the third salt comprises calcium chloride.

In one embodiment, the second method further comprises agitating, e.g., via stirring, the hydrocolloid material prior to combination with the hydrated protein material. In one embodiment, the hydrocolloid material may be agitated for about 10 minutes to about one hour.

In one embodiment, the second method further comprises agitating, e.g., via stirring, the second mixture prior to addition of the first solution thereto. In one embodiment, the second mixture may be agitated for about 2 to about 15 minutes.

In one embodiment, the third mixture may be in the form of a paste. Moreover, in one embodiment, the third mixture may be agitated, e.g., via stirring, prior to deposition thereof in the second solution. In one embodiment, the third mixture may be agitated for about 2 minutes to about 15 minutes. In one embodiment, the third mixture, after said agitating, may have a smooth appearance.

In one embodiment, the second method further comprises adding one or more optional coloring agents to impart a red or substantially red color to the resulting edible composition. The one or more coloring agents may independently be added at any of steps (ii) to (v) of the second method. In one exemplary embodiment, the second solution may include at least one coloring agent, such that one or more portions of the third mixture, upon immersion/deposition in the second solution, retain a red or substantially red color.

In one embodiment, the second method further comprises preparing the at least one hydrocolloid material. Preparation of the hydrocolloid material may comprise: combining at least one hydrocolloid composition with water to form a third solution; and adding sodium citrate and an alkali slurry to the third solution to form the hydrocolloid material, wherein the alkali slurry comprises an alkali salt and water.

In one embodiment, two different hydrocolloid compositions are combined with water to form the third solution. For instance, in one such embodiment, the first hydrocolloid composition may comprise one or more of: konjac gum, microcrystalline cellulose, starch, and sodium carboxymethylcellulose, and the second hydrocolloid composition may comprise sodium alginate.

In one embodiment, preparation of the hydrocolloid material further comprises agitating, e.g., via stirring, the hydrocolloid composition(s) with crushed ice prior to combination with water to form the third solution.

In one embodiment, preparation of the hydrocolloid material further comprises agitating, e.g., via stirring, the third solution for about 5 to about 25 minutes prior to addition of the alkali slurry thereto.

In one embodiment, preparation of the hydrocolloid material further comprises agitating, e.g., via stirring, the combined alkali slurry and third solution for about 2 to about 3 minutes. The resulting hydrocolloid material may preferably have a pH in a range from about 10.5 to 11.0. The resulting hydrocolloid material may additionally be refrigerated for about 6 to about 24 hours for hydration purposes prior to being added to the hydrated protein material (e.g., step (ii) of the second method).

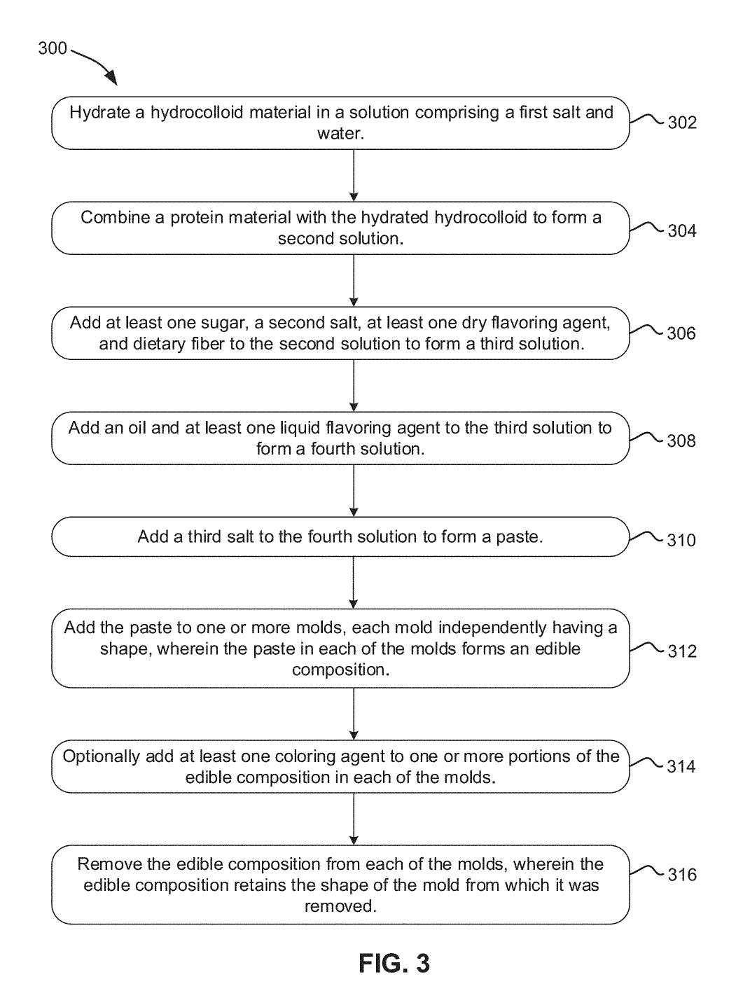

FIG. 3 illustrates a flowchart of a third method 300 of making an edible composition, such as disclosed herein, according to one embodiment. As shown in FIG. 3, the method 300 comprises:
hydrating a hydrocolloid material in a solution comprising a first salt and water (step 302);
combining a protein material with the hydrated hydrocolloid to form a second solution (step 304);
adding at least one sugar, a second salt, at least one dry flavoring agent, and dietary fiber to the second solution to form a third solution (step 306);
adding an oil and at least one liquid flavoring agent to the third solution to form a fourth solution (step 308); and adding a third salt to the fourth solution to form a paste (step 310).

In one embodiment, the hydrocolloid material may be hydrated in the solution comprising the first salt and water for about 30 minutes to about 2 hours, and particularly for about 1.5 hours.

In one embodiment, the second solution comprising the protein material, hydrated hydrocolloid material, the first salt, and water may be allowed to rest undisturbed for about 5 minutes to about 30 minutes, and particularly for about 15 minutes, prior to implementation of step 306.

In one embodiment, the third solution may be agitated, e.g., via stirring, during the addition of the algal/algae oil and the at least one liquid flavoring agent thereto.

In one embodiment, the fourth solution may be agitated, e.g., via stirring, for about 1 minute to about 15 minutes, and particularly about 2 minutes, during the addition of the third salt thereto. In one embodiment, the paste, after said agitating, may have a smooth appearance.

The ingredients used to form the edible composition may be any applicable ingredient disclosed herein. For instance, in one embodiment, the hydrocolloid material is sodium alginate. In one embodiment, the protein material is a soy protein isolate, a soy protein concentrate, or combinations thereof. In one embodiment, the protein material is a soy protein concentrate. In one embodiment, the at least one sugar is evaporated cane juice. In one embodiment, the at least one dry flavoring agent and the at least one liquid flavoring agent are each independently a natural, vegan shrimp flavoring agent. In one embodiment, the oil is an algal/algae oil, avocado oil, olive oil, or combinations thereof. In one embodiment, the oil is avocado oil. In one embodiment, the oil is olive oil. In one embodiment, the oil is algal/algae oil. In one embodiment, the dietary fiber is bamboo fiber, citrus fiber, or combinations thereof. In one embodiment, the dietary fiber is citrus fiber. In one embodiment, the dietary fiber is bamboo fiber. In one embodiment, the water used to form the edible composition is deionized water. In one embodiment, the water used to form the edible composition is sea water.

In one embodiment, the first salt, the second salt, and the third salt may be the same or different from one another with respect to composition, amount thereof in the edible composition, etc. In one embodiment, the first salt comprises sodium citrate. In embodiment, the second salt comprises calcium chloride. In one embodiment, the second salt comprises sea salt.

In one embodiment, the third salt comprises calcium lactate. In one embodiment, the third salt is combined with water prior to addition to the fourth solution.

As also shown in FIG. 3, the third method 300 comprises adding the paste to one or more molds, where each mold independently has a shape (step 312). In one embodiment, the one or more molds may be part of a single sheet. In one embodiment, each of the molds may be an independent structure. In one embodiment, each of the molds independently comprises a shape that substantially mimics that of a shrimp, a lobster/langoustine, a fish stick, a fish nugget, a fish fillet, a scallop, a crab claw, a crab cake, a crab stick, or other desired type of seafood. In one embodiment, each of the molds may have a shape that substantially mimics that of a shrimp having no head or tail.

After a predetermined time period, the paste in each of the molds forms an edible composition comprising the shape of the respective mold (step 312). In one embodiment, this predetermined time period may be tailored to achieve an edible composition having a desired consistency. In one embodiment, this predetermined time period is about 15 minutes.

In one embodiment, the third method 300 comprises forming the edible composition having one or more enhanced colors. The method 300 may therefore optionally include adding at least one coloring agent to one or more portion of the edible composition in each of the molds (step 314). In one such embodiment, the at least one coloring agent may be coated/sprayed on one or more portion of each of the molds prior to addition of the paste thereto. Once the paste is added to the molds, the coloring agent(s) may be transferred to one or more portions of the paste, and thus to one or more portions of the resulting edible composition. In one exemplary embodiment, at least one of the one or more coloring agents may impart a substantially red or pink color to the paste, and ultimately to the resulting edible composition.

As additionally shown in FIG. 3, the method 300 comprises removing the edible composition from each of the molds, where the edible composition retains the shape of the mold from which it was removed (step 316).

As indicated previously, the resulting edible compositions, formed by the methods disclosed herein and/or via other methods as would be appreciated by skilled artisans upon reading the present disclosure, may have the taste, texture, and appearance of wild-caught or farmed shrimp, yet comprise no animal products or animal byproducts. In one embodiment, the edible compositions disclosed herein may also have the same nutritional values (e.g., the same amount of whole protein and/or fat content) as wild-caught or farmed shrimp. The edible compositions disclosed herein may thus serve as a shrimp-substitute product for human consumption.

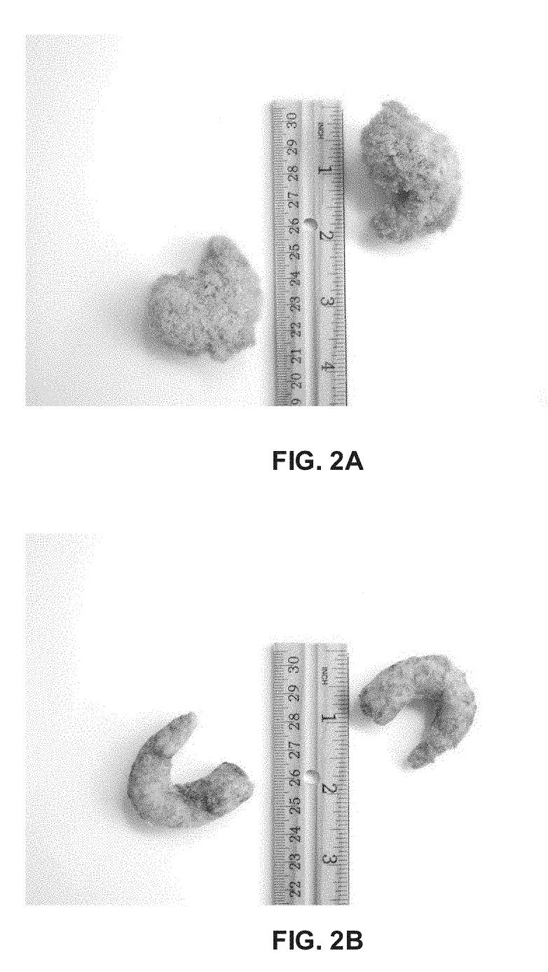

Moreover, the resulting edible compositions may be seasoned, breaded, chopped, sautéed, fried, boiled, broiled, baked, and/or subject to other culinary processes for the purposes of human consumption, in one embodiment. It has been found that the disclosed edible compositions react to such culinary processes in an equivalent or substantially equivalent fashion as wild-caught or farmed shrimp. Accordingly, in one embodiment, the resulting edible compositions may be a breaded shrimp substitute product, a panko breaded shrimp substitute product, a partially or fully fried shrimp substitute product, a grilled shrimp substitute product, or a tempura shrimp substitute product. FIG. 2A illustrates an exemplary embodiment of breaded shrimp substitute product, and FIG. 2B illustrates an exemplary embodiment of a non-breaded (raw) shrimp substitute product for reference. FIGS. 2A-2B also illustrate relative dimensions of the breaded and raw shrimp substitute products, respectively; however, said dimensions are in no way limiting to the shrimp or other seafood substitute products disclosed herein.

The resulting edible compositions formed by the methods disclosed herein and/or via other methods as would be appreciated by skilled artisans upon reading the present disclosure are not limited to shrimp-substitute products. For example, in some embodiments, the resulting edible compositions may have the taste, texture, and appearance of other wild-caught or farmed seafood (e.g., lobster, langoustine, a desired fish, scallops, crab, etc.), yet comprise no animal products or animal byproducts. In one embodiment, the edible compositions disclosed herein may also have the same nutritional values (e.g., the same amount of whole protein and/or fat content) as wild-caught or farmed lobster, langoustine, a desired fish, scallops, crab, etc. The ingredients disclosed herein and their respective amount may thus be tailored to achieve any desired seafood substitute product having a desired flavor and/or consistency. Further, these seafood substitute products may be subject to any culinary process disclosed herein (breading, frying, grilling, etc.).

### EXAMPLES

The following examples are provided to demonstrate methods of preparing edible compositions and/or components thereof according to various embodiments.

1. Edible Composition A

Edible composition A was prepared by first combining high acyl gellan gum, low acyl gellan gum, a soy protein isolate, and water to form solution 1. Solution 1 was stirred until homogeneous, and set aside for about 15 minutes, after which extra virgin olive oil was added thereto. Solution 1 was then heated to about 90° C. while stirring occasionally, until said solution became viscous.

White, granulated sugar and calcium chloride was dissolved in water to form solution 2. Solution 2 was then heated to about 85° C.

Heated solution 1 and heated solution 2 were subsequently combined and stirred until a homogenous mixture formed. The mixture was neither firm nor fibrous, but found to be viscous. The mixture was next placed into a silicon mold having the shape of shrimp with no head or tail, and allowed to rest about five minutes, after which the mixture was removed from the mold to yield an edible composition retaining the shape of the shrimp.

A coating of astaxanthin was applied to the exterior surface of the shrimp-shaped edible composition to impart the flavor and color similar to that of wild-caught or farmed shrimp. In one embodiment, the astaxanthin may be added to the mixture prior to the molding process, instead of coated on the resulting edible composition thereafter.

A summary of the ingredients and their relative amounts in the resulting edible composition A is presented in Table 1 below.

TABLE 1
Edible Composition A

| | Amount | |
|---|---|---|
| | (based on the total weight of the | |
| Ingredient | edible composition) | |
| High acyl gellan gum | 1.94 | wt. % |
| Low acyl gellan gum | 1.94 | wt. % |
| Extra virgin olive oil | 0.63 | wt. % |
| CaCl₂ | 0.02 | wt. % |
| White, granulated sugar | 0.97 | wt. % |
| Astaxanthin (5%) | 0.05 | wt. % |
| Soy isolate (80% protein) | 6.80 | wt. % |
| Deionized water | 87.65 | wt. % |

2. Hydrocolloid Material

A hydrocolloid material was formed by combining and agitating (e.g., via stirring/mixing) a first hydrocolloid composition comprising konjac gum, microcrystalline cellulose, starch (modified and native starch), and sodium carboxymethyl cellulose, a second hydrocolloid composition comprising sodium alginate, and crushed ice. Water was then added to the first hydrocolloid composition, the second hydrocolloid composition, and the crushed ice to form a first solution. The first solution was agitated, e.g., via stirring/mixing, for about 5 to about 10 minutes.

Sodium citrate, and an alkali slurry comprising calcium hydroxide and water was slowly added to the first solution to form the resulting hydrocolloid material having a pH in a range from about 10.5 to about 11. The combined alkali slurry and first solution were agitated, e.g., via stirring/mixing, for about 2 to 3 minutes to ensure even distribution of the components.

A summary of the ingredients and their relative amounts in the alkali slurry and the hydrocolloid material is presented in Tables 2 and 3 below, respectively.

TABLE 2
Alkali Slurry

| | Amount | |
|---|---|---|
| | (based on the total weight of the | |
| Ingredient | alkali slurry) | |
| Water | 95.24 | wt. % |
| Ca(OH)₂ | 4.76 | wt. % |

TABLE 3
Hydrocolloid Material

| | Amount | |
|---|---|---|
| | (based on the total weight of the | |
| Ingredient | hydrocolloid material) | |
| Water | 71.85 | wt. % |
| Crushed ice | 20.00 | wt. % |
| First hydrocolloid composition | 5.00 | wt. % |
| Second hydrocolloid composition | 2.00 | wt. % |
| Sodium citrate | 0.10 | wt. % |
| Alkali slurry | 1.05 | wt. % |

3. Edible Composition B

Edible composition B was prepared by first combining soy protein isolate in water, and allowing the hydrated soy protein isolate to sit undisturbed for about 15 minutes. The hydrocolloid material of Example 2 was then added to the hydrated soy protein isolate to form a first mixture, and the first mixture was agitated, e.g., via stirring/mixing, at least until the components thereof were fully combined.

Bamboo fiber, sugar, sodium chloride, algae oil, and shrimp flavoring agents were added to the first mixture to form a second mixture. The second mixture was agitated, e.g., via stirring/mixing for about 2 to about 3 minutes.

A calcium lactate solution comprising calcium lactate and water was subsequently added to the second mixture to form a third mixture in the form of a paste. The third mixture/paste was agitated, e.g., via stirring/mixing for about 2 to about 3 minutes until the third mixture/paste had a smooth appearance.

The third mixture/paste was next deposited/immersed in a calcium chloride solution comprising calcium chloride and water for about 20 minutes. The third mixture/paste was then removed from the calcium chloride solution to yield the resulting edible composition.

In some embodiments, the resulting edible composition may be molded to have the shape of shrimp.

A summary of the ingredients and their relative amounts in the calcium lactate solution and edible composition B is presented in Tables 4 and 5 below, respectively.

TABLE 4
Calcium Lactate Solution

| | Amount | |
|---|---|---|
| | (based on the total weight of the | |
| Ingredient | calcium lactate solution) | |
| Water | 91.00 | wt. % |
| Calcium lactate | 9.00 | wt. % |

TABLE 5
Edible Composition B

| | Amount | |
|---|---|---|
| | (based on the total weight of the | |
| Ingredient | edible composition) | |
| Hydrocolloid material | 68.00 | wt. % |
| Soy protein isolate | 10.00 | wt. % |
| Bamboo fiber | 1.00 | wt. % |
| Water | 14.88 | wt. % |
| Sugar | 1.20 | wt. % |
| Sodium chloride | 0.50 | wt. % |
| Algae oil | 2.50 | wt. % |
| Shrimp flavoring agents | 0.42 | wt. % |
| Calcium lactate solution | 1.50 | wt. % |

4. Edible Composition C

Edible composition C was prepared using substantially the same method as edible composition B (Example 3), with the exception that lycopene was added to the calcium chloride solution prior the third mixture being deposited/immersed therein. The addition of lycopene to the calcium chloride solution provides a desired color to the third mixture upon deposition/immersion therein.

A summary of the ingredients and their relative amounts in edible composition C is presented in Table 6 below.

TABLE 6
Edible Composition C

| | Amount | |
|---|---|---|
| | (based on the total weight of the | |
| Ingredient | edible composition) | |
| Hydrocolloid material | 68.00 | wt. % |
| Soy protein isolate | 10.00 | wt. % |
| Bamboo fiber | 1.00 | wt. % |
| Water | 14.48 | wt. % |
| Sugar | 1.20 | wt. % |
| Sodium chloride | 0.50 | wt. % |
| Algae oil | 2.50 | wt. % |
| Lycopene | 0.40 | wt. % |
| Shrimp flavoring agents | 0.42 | wt. % |
| Calcium lactate solution | 1.50 | wt. % |

5. Edible Composition D

Edible composition D was prepared by combining edible composition B (Example 3) and edible composition C (Example 4). In some embodiments, edible composition D comprises from about 0.1 wt. % to about 99.9 wt./% of edible composition B, and from about 0.1 wt. % to about 99.9 wt./% edible composition C, wherein the weight percentages are based on the total weight of edible composition D. In one embodiment, edible composition D comprises more of edible composition B than of edible composition C.

In some embodiments, the resulting edible composition may be breaded. A summary of the ingredients and their relative amounts in breaded edible composition D is presented in Table 7 below.

TABLE 7
Breaded Edible Composition D

| | Amount | |
|---|---|---|
| | (based on the total weight of the | |
| Ingredient | edible composition) | |
| Edible Composition B | 72.86 | wt. % |
| Edible Composition C | 0.81 | wt. % |
| Predust | 1.79 | wt. % |
| Batter | 11.36 | wt. % |
| Breading | 13.18 | wt. % |

6. Edible Composition E

Edible composition E was prepared by first combining sodium citrate and a hydrocolloid material in water, optionally agitating (e.g., via stirring/mixing) the resulting solution, and allowing the solution to sit undisturbed for about 1.5 hours. Textured soy protein concentrate was subsequently added to the solution, after which the solution was allowed to sit undisturbed for about 15 minutes.

The hydrocolloid material of edible composition E was not limited to the hydrocolloid material of Example 2. For instance, in some embodiments, the hydrocolloid material of edible composition E comprised sodium alginate. In some embodiments, the hydrocolloid material of edible composition E was comprised primarily of, or consisted of, sodium alginate.

Sugar, salt, bamboo fiber, and dry flavoring agents were mixed together and added to the above solution, followed by agitation of thereof. Algae oil combined with liquid flavoring agents were next added to the solution during agitation thereof In some embodiments, the sugar was derived from evaporated cane juice. In some embodiments, the salt was sea salt. In some embodiments, the dry and liquid flavoring agents are dry and liquid shrimp flavoring agents (e.g., impart a shrimp flavor).

A calcium lactate solution, such as described in Table 4 of Example 3, was subsequently added to the solution to form a paste. The paste was agitated until the paste had a smooth appearance, thereby forming edible composition E.

In some embodiments, edible composition E may be placed into molds each independently having a predetermined shape (e.g., a shape of a shrimp, lobster/langoustine, fish stick/fish nugget, scallop, fish fillet, crab claw, crab claw, or other types of seafood). In an exemplary embodiment, each of molds may have the shape of a shrimp.

In embodiments in which edible composition E may be formed into a shape of a shrimp, lobster/langoustine, fish stick/fish nugget, scallop, fish fillet, crab claw, crab claw, etc., the corresponding type of flavoring agents (dry and/or liquid) may be added to the composition. For instance, in embodiments in which edible composition E may be formed into a crab stick or crab claw, dry and liquid crab flavoring agents may be used in said composition.

In some embodiments, at least one coloring agent may be added to edible composition E to form “edible composition E with enhanced color.” The addition of the at least one coloring agent to edible composition E may occur before the composition is added to the aforementioned molds, during the time period in which composition is located in the molds, after removal of the composition from the molds, or any combination thereof. For instance, in one exemplary embodiment, a coloring solution comprising the at least one coloring agent may be sprayed/coated on one or more portions of each mold prior to addition of edible composition E thereto. Accordingly, the coloring solution, and thus the at least one coloring agent, may be transferred to one or more portions of edible composition E upon addition of the composition to the molds.

The coloring agent may be configured to impart a color corresponding to the type of seafood (e.g., shrimp, lobster/langoustine, fish, scallop, crab, etc.) that the edible composition E will take the shape of. For instance, in embodiments in which edible composition is molded to have the shape of a shrimp, the coloring agent may impart a coloring to the composition that substantially mimics wild-caught or farmed shrimp. Table 10 below provides one example in which the coloring agent is lycopene.

Further, in some embodiments, edible composition E with or without enhanced color may be further subject to any culinary process disclosed herein, such as breading, frying, grilling, etc. In one embodiment edible composition may be breaded. In one embodiment, edible composition E may be subject to a breading process as described in Example 5.The breading of the edible composition E may occur, e.g., after said composition is molded into desired predetermined shapes.

A summary of the ingredients and their relative amounts in edible composition E, edible composition E with enhanced color, and the coloring solution is presented in Tables 8-10 below, respectively.

TABLE 8
Edible Composition E

| | Amount | |
|---|---|---|
| | (based on the total weight of | |
| Ingredient | the edible composition) | |
| Water | 72.96 | wt. % |
| Textured soy concentrate | 10.00 | wt. % |
| Sugar | 4.80 | wt. % |
| Hydrocolloid Material | 3.90 | wt. % |
| Algae oil | 2.75 | wt. % |
| Calcium lactate solution | 2.76 | wt. % |
| Salt | 1.15 | wt. % |
| Bamboo fiber | 0.80 | wt. % |
| Flavoring agents | 0.81 | wt. % |
| Sodium citrate | 0.06 | wt. % |

TABLE 9
Edible Composition E with Enhanced Color

| | Amount | |
|---|---|---|
| | (based on the total weight of | |
| Ingredient | the edible composition) | |
| Water | 72.24 | wt. % |
| Textured soy concentrate | 9.90 | wt. % |
| Sugar | 4.75 | wt. % |
| Hydrocolloid material | 3.86 | wt. % |
| Algae oil | 2.72 | wt. % |
| Calcium lactate solution | 2.73 | wt. % |
| Salt | 1.14 | wt. % |
| Bamboo fiber | 0.79 | wt. % |
| Flavoring agents | 0.81 | wt. % |
| Sodium citrate | 0.06 | wt. % |
| Coloring Solution | 0.99 | wt. % |

TABLE 10
Coloring Solution

| | Amount |
|---|---|
| | (based on the total weight of the |
| Ingredient | coloring solution) |
| Water | 90.00 wt. % |
| Lycopene | 10.00 wt. % |

7. Edible Composition F

Edible composition F may be prepared by any of the methods described herein, with or without applicable modifications as would be apparent to skilled artisans upon reading the present disclosure. In some embodiments, In some embodiments, edible composition F may be prepared using substantially the same method as edible composition C (Example 4). In some embodiments, edible composition F may be prepared using substantially the same method as edible composition E (Example 6).

A summary of the ingredients and their relative amounts in edible composition F is presented in Table 11 below.

TABLE 11
Edible Composition F

| | Amount | |
|---|---|---|
| | (based on the total weight of | |
| Ingredient | the edible composition) | |
| Hydrocolloid material | 7.75 | wt. % |
| Soy protein isolate | 15.00 | wt. % |
| Bamboo fiber | 1.50 | wt. % |
| Water | 70.00 | wt. % |
| Sugar | 1.20 | wt. % |
| Salt | 0.50 | wt. % |
| Algae oil | 2.50 | wt. % |
| Coloring agent | 0.25 | wt. % |
| Flavoring agents | 0.40 | wt. % |
| Calcium lactate solution | 0.90 | wt. % |

In some embodiments, the hydrocolloid material of edible composition F is substantially the same as the hydrocolloid material described in Example 2. However, in some embodiments, the hydrocolloid material in edible composition F is not limited to the hydrocolloid material described in Example 2, but may include any hydrocolloid materials disclosed herein. For instance, in one embodiments, the hydrocolloid material may include sodium alginate. In one particular embodiments, the hydrocolloid material may be comprised primarily of, or consist of, sodium alginate.

In some embodiments, the soy protein isolate of edible composition F may be replaced with, or used in conjunction with, soy protein concentrate, provided that the total weight percent of the soy protein material is about 15 wt. %.

In some embodiments, the calcium lactate solution of edible composition F may be as described in Table 4 of Example 3.

In some embodiments, the salt in edible composition F may comprise sodium chloride. In some embodiments, the salt in edible composition F may be characterized as sea salt.

In some embodiments, edible composition F may be placed into molds each independently having a predetermined shape (e.g., a shape of a shrimp, lobster/langoustine, fish stick/fish nugget, scallop, fish fillet, crab claw, crab claw, or other types of seafood). In an exemplary embodiment, each of molds may have the shape of a shrimp.

In embodiments in which edible composition F may be formed into a shape of a shrimp, lobster/langoustine, fish stick/fish nugget, scallop, fish fillet, crab claw, crab claw, etc., the corresponding type of flavoring agents (dry and/or liquid) may be added to the composition. For instance, in embodiments in which edible composition F may be formed into a crab stick or crab claw, dry and liquid crab flavoring agents may be used in said composition.

Similarly, in some embodiments, the coloring agent may be configured to impart a color corresponding to the type of seafood (e.g., shrimp, lobster/langoustine, fish, scallop, crab, etc.) that the edible composition F will take the shape of. For instance, in embodiments in which edible composition is molded to have the shape of a shrimp, the coloring agent may impart a coloring to the composition that substantially mimics wild-caught or farmed shrimp. In some embodiments, the coloring agent may be lycopene.

Moreover, in some embodiments, edible composition F may be subject to any culinary process disclosed herein, such breading, frying, grilling, etc. In one embodiment, edible composition F may be subject to a breading process as described in Example 5.

8. Edible Composition G

Edible composition G may be prepared by any of the methods described herein, with or without applicable modifications as would be apparent to skilled artisans upon reading the present disclosure. In some embodiments, In some embodiments, edible composition G may be prepared using substantially the same method as edible composition C (Example 4). In some embodiments, edible composition G may be prepared using substantially the same method as edible composition E (Example 6).

A summary of the ingredients and their relative amounts in edible composition F is presented in Table 12 below.

TABLE 12
Edible Composition G

| | Amount | |
|---|---|---|
| | (based on the total weight of | |
| Ingredient | the edible composition) | |
| Hydrocolloid material | 4.00 | wt. % |
| Soy protein isolate | 8.00 | wt. % |
| Bamboo fiber | 1.50 | wt. % |
| Water | 75.00 | wt. % |
| Sugar | 3.00 | wt. % |
| Salt | 0.50 | wt. % |
| Algae oil | 3.00 | wt. % |
| Coloring agent | 0.25 | wt. % |
| Flavoring agents | 0.40 | wt. % |
| Calcium lactate solution | 2.10 | wt. % |

In some embodiments, the hydrocolloid material in edible composition G is substantially the same as the hydrocolloid material described in Example 2. However, in some embodiments, the hydrocolloid material in edible composition G is not limited to the hydrocolloid material described in Example 2, but may include any hydrocolloid materials disclosed herein. For instance, in one embodiments, the hydrocolloid material may include sodium alginate. In one particular embodiments, the hydrocolloid material may be comprised primarily of, or consist of, sodium alginate.

In some embodiments, the soy protein isolate of edible composition G may be replaced with, or used in conjunction with, soy protein concentrate, provided that the total weight percent of the soy protein material is about 15 wt. %.

In some embodiments, the calcium lactate solution of edible composition G may be as described in Table 4 of Example 3.

In some embodiments, the salt in edible composition G may comprise sodium chloride. In some embodiments, the salt in edible composition G may be characterized as sea salt.

In some embodiments, edible composition G may be placed into molds each independently having a predetermined shape (e.g., a shape of a shrimp, lobster/langoustine, fish stick/fish nugget, scallop, fish fillet, crab claw, crab claw, or other types of seafood). In an exemplary embodiment, each of molds may have the shape of a shrimp.

In embodiments in which edible composition G may be formed into a shape of a shrimp, lobster/langoustine, fish stick/fish nugget, scallop, fish fillet, crab claw, crab claw, etc., the corresponding type of flavoring agents (dry and/or liquid) may be added to the composition. For instance, in embodiments in which edible composition F may be formed into a crab stick or crab claw, dry and liquid crab flavoring agents may be used in said composition.

Similarly, in some embodiments, the coloring agent may be configured to impart a color corresponding to the type of seafood (e.g., shrimp, lobster/langoustine, fish, scallop, crab, etc.) that the edible composition F will take the shape of. For instance, in embodiments in which edible composition is molded to have the shape of a shrimp, the coloring agent may impart a coloring to the composition that substantially mimics wild-caught or farmed shrimp. In some embodiments, the coloring agent may be lycopene.

Moreover, in some embodiments, edible composition F may be subject to any culinary process disclosed herein, such breading, frying, grilling, etc. In one embodiment, edible composition F may be subject to a breading process as described in Example 5.

It is understood that the invention described and claimed herein is not to be limited in scope by the specific exemplary embodiments disclosed herein, as these embodiments are intended as illustrations of several aspects of the invention. Indeed, various modifications of the invention in addition to those shown and described herein will become apparent to those skilled in the art from the foregoing description. Such modifications are also intended to fall within the scope of the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein. In addition, where features or aspects of the invention are described in terms of Markush groups, those skilled in the art will recognize that the invention is also thereby described in terms of any individual member or subgroup of members of the Markush group.

What is claimed is:

1. An edible composition, comprising:
a hydrocolloid material;
a protein material; and
an algal extract.

2. The edible composition of claim 1, wherein the hydrocolloid material is present in an amount from about 0.5 wt. % to about 10 wt. %.

3. The edible composition of claim 2, wherein the hydrocolloid material comprises sodium alginate.

4. The edible composition of claim 1, wherein the protein material is present in an amount from about 0.1 wt. % to about 30 wt. %.

5. The edible composition of claim 4, wherein the protein material is selected from a soy protein isolate, a soy protein concentrate, a pea protein isolate, a pea protein concentrate, a rice protein isolate, a rice protein concentrate, a potato protein isolate, a potato protein concentrate, a chick-pea protein isolate, a chick-pea protein concentrate, an algal isolate, an algal concentrate, and combinations thereof.

6. The edible composition of claim 4, wherein the protein concentrate comprises soy concentrate.

7. The edible composition of claim 1, wherein the algal extract is present in an amount from about 0.0001 wt. % to about 1 wt. %.

8. The edible composition of claim 7, wherein the algal extract comprises an extract from Haematococcus pluvialis.

9. The edible composition claim 7, wherein the algal extract comprises astaxanthin.

10. The edible composition of claim 1, further comprising one or more additional ingredients selected from:
a salt in an amount from about 0.001 wt. % to about 3 wt. %;
an oil present in an amount from about 0.1 wt. % to about 10 wt. %;
a sugar present in an amount from about 0.1 wt. % to about 6 wt. %;
a dietary fiber present in amount from about 0.1 wt. % to about 2 wt. %; and
water present in an amount from about 50 wt. % to about 95 wt. %.

11. The edible composition of claim 10, wherein the salt comprises calcium chloride.

12. The edible composition of claim 10, wherein the oil is selected from algae oil, olive oil, avocado oil, and combinations thereof.

13. The edible composition of claim 10, wherein the dietary fiber is selected from bamboo fiber, citrus fiber, and combinations thereof.

14. The edible composition of claim 1, further comprising a coloring agent selected from lycopene, paprika, beta-carotene, and combinations thereof.

15. The edible composition of claim 1, comprising no more than about 0.001 wt. % of starch, and no more than about 0.001 wt. % of gluten.

16. The edible composition of claim 1, comprising no more than about 0.001 wt. % of products or byproducts of animal origin.

17. The edible composition of claim 16, wherein the edible composition is a seafood substitute product.

18. The edible composition of claim 16, wherein the edible composition is a shrimp substitute product having the form of a shrimp.

19. A method of making an edible composition, the method comprising:
combining a hydrocolloid material, a protein material, and water to form a first solution;
adding an oil to the first solution after a predetermined amount of time has elapsed from combining the hydrocolloid material, the protein material, and the water;
heating the first solution;
combining a sugar and a salt to form a second solution;
heating the second solution; and
combining the first and second solutions to form the edible composition.

20. The method of claim 19, further comprising:
adding the edible composition to one or more molds, each independently having a predetermined shape;
optionally adding a coloring agent to the edible composition when present in the one or more molds; and
removing the edible composition from the one or more molds, the edible composition having the predetermined shape of the respective molds from which it was removed.

21. The method of claim 19, wherein:
the hydrocolloid material comprises sodium alginate;
the protein material is selected from a protein isolate, a protein concentrate, a pea protein isolate, a pea protein concentrate, a rice protein isolate, a rice protein concentrate, a potato protein isolate, a potato protein concentrate, a chick-pea protein isolate, a chick-pea protein concentrate, an algal isolate, an algal concentrate, and combinations thereof;
the salt comprises calcium chloride; and
the oil is selected from algae oil, olive oil, avocado oil, and combinations thereof.

22. A seafood substitute product for human consumption, the product comprising:
a hydrocolloid material present in an amount from about 0.5 wt. % to about 10 wt. %;
a protein material present in an amount from about 0.1 wt. % to about 30 wt. %; and
an algal extract present in an amount from about 0.0001 wt. % to about 1 wt. %.

23. The product of claim 22, further comprising one or more additional ingredients selected from:
a salt in an amount from about 0.001 wt. % to about 3 wt. %;
an oil present in an amount from about 0.1 wt. % to about 10 wt. %;
a sugar present in an amount from about 0.1 wt. % to about 6 wt. %;
a dietary fiber present in amount from about 0.1 wt. % to about 2 wt. %; and
water present in an amount from about 50 wt. % to about 95 wt. %.

24. The product of claim 22, comprising no more than about 0.001wt. % of products or byproducts of animal origin.

25. The product of claim 24, having substantially the same texture, form, and appearance of wild-caught or farmed shrimp.
